(19) United States
(12) Patent Application Publication
(10) Pub. No.: US 2015/0373994 A1
(43) Pub. Date: Dec. 31, 2015

(54) COMPOSITIONS AND METHODS FOR TREATING PESTS

(71) Applicant: NOVOZYMES BIOAG A/S, Bagsvaerd (DK)

(72) Inventors: Jarrod Leland, Salem, VA (US); Koji Hiratsuka, Salem, VA (US); Kenneth Edmund Kellar, Salem, VA (US)

(21) Appl. No.: 14/762,114

(22) PCT Filed: Jan. 28, 2014
(86) PCT No.: PCT/US2014/013274

§ 371 Date: Jul. 20, 2015

Related U.S. Application Data
(60) Provisional application No. 61/757,356, filed on Jan. 28, 2013.

(51) Int. Cl. A01N 63/04; A01N 63/00

(52) U.S. Cl. CPC A01N 63/04; A01N 63/00

(57) ABSTRACT

Disclosed herein are pest controlling compositions comprising entomopathogenic fungi which are horizontally transmissible across pest populations and control target pests at various life stages. Further disclosed are methods of using such compositions for controlling pests, including, bed bugs and other invasive parasitic pests.

### FIELD OF THE INVENTION

Disclosed herein are insect control compositions comprising entomopathogenic fungi. Further disclose are methods of using such compositions for controlling pests, including bed bugs and other invasive parasitic pests.

### BACKGROUND OF THE INVENTION

Pest infestation is a common problem in households and industrial settings and in agricultural industries. Many products are available for controlling arthropod pests such as insects and for preventing new infestations. However, bed bug infestations have proven particularly difficult to eradicate. Dwellings, such as homes and hotels, become infested with bed bugs in a variety of ways. Bed bugs and eggs can be inadvertently transmitted from other infested dwellings by visiting pets or a visiting person's clothing or luggage, nearby dwellings (through duct work or false ceilings), or wild animals (such as bats or birds) that may also harbor bed bugs.

Moreover, bed bugs infestations are not easily resolved as bed bugs are elusive and usually nocturnal making them hard to spot. Bed bugs will often lodge themselves unnoticed in dark crevices, and eggs nestled in fabric seams. As bed bugs are parasitic insects that feed on the blood of its host, bed bugs usually remain close to places where potential hosts reside; commonly in or near beds or couches in the instance of human hosts.

Solutions for controlling pest populations, including bed bugs, typically require a combination of pesticide and nonpesticide approaches. Pesticides that have historically been found to be effective include pyrethroids, dichlorvos and malathion. Pests, such as bed bugs, have become increasingly resistant to pesticides, however, and negative health effects from their use are of concern. The carbamate insecticide propoxur is highly toxic to bed bugs, but in the United States, the Environmental Protection Agency (EPA) has been reluctant to approve such an indoor use because of its potential toxicity to children after chronic exposure. Mechanical approaches to eliminating bed bugs have also been explored and include vacuuming up the insects and heat treating or wrapping mattresses.

Common solutions to pest infestations, including infestations of Cimicidae, such as Cimex lectularius (the common bed bug), provide physical barriers between the pest and their human hosts. These solutions often include the use of disposable devices containing an adhesive to immobilize pests following contact with the adhesive (e.g., adhesive tapes, fly tapes, etc.). Once the device is saturated with immobilized pests, the device is removed, disposed of, and replaced. This process is repeated. Such a solution, however, does not solve the larger infestation problem at hand as these solutions only capture the pests. Moreover, these adhesive devices are fraught with additional challenges. Typically these devices are not reusable items once they become saturated with immobilized pests, and/or the adhesive can lose its effectiveness due to dust and other contaminants.

U.S. Patent Application Publication Number No.: 2006/0110366 discloses a method of selective application of entomopathogenic fungi, characterized by employing an attractant-contaminant device in which the spores of the fungus are fixed on an adsorbent material; this same adsorbent material or another, depending on the case, incorporates a specific attractant and is located on an adherent material. This adherent material can, in certain cases, incorporate a gelling agent and different additives, which maintain the adequate level of humidity for the survival of the spores.

Pedrini, N., et al., Control of pyrethroid-resistant Chagas disease vectors with entomopathogenic fungi. PLoS Neg. Trop. Dis. 3(5): e434. doi:10.1371/journal.pntd.0000434 (2009) discloses using the entomopathogenic fungus, Beauveria bassiana, could help control the spread of pyrethroid resistant bugs, in particular Triatoma infestans.

Barbarin, A. M., et al., A preliminary evaluation of the potential of Beauveria bassiana for bed bug control. J. Invertebr. Pathol. (2012) discloses biopesticide treatments of Beauveria bassiana tested against the bed bug Cimex lectularius.

U.S. Patent Application Publication No.: 2012/0039976 discloses utilizing extracts of the pre-sporulation (preconidia) mycelia stage of entomopathogenic fungi as insect and arthropod attractants and/or pathogens.

Published PCT Patent Application No.: WO 95/10597 discloses entomopathogenic formulations that include conidia of an entomopathogenic fungus and a carrier. Methods of killing insects such as grasshoppers using the disclosed formulations are described.

U.S. Pat. No. 5,888,989 discloses insecticidal and acaricidal compositions of silafluofen and at least one entomopathogenic fungus, such as, for example, Beauveria bassiana.

U.S. Patent Application Publication No.: 2010/0112060 describes insecticidal compositions comprising spores of entomopathogenic fungi suspended in oil in water emulsions comprising fatty acid salts, polyhydric alcohols, and additional emulsifiers. The publication further describes methods for using the compositions for preventing and controlling insect infestation in animals and natural areas—in particular, tick infestations are disclosed.

German Patent Application Publication No.: DE 19707178 discloses insecticidal or acaricidal compositions.

Published PCT Patent Application No.: WO 11/099022 discloses compositions and methods of preparing the composition and methods for preparing fungal based products from innovative combination of dormant spore of naturally occurring Metarhizium anisopliae, Beauveria bassiana and Verticillium lecanii fungus with enzymes, fats and growth promoting molecules. Uses for controlling pests like aphids, whitefly, thrips, mite, jassids, Mealybug, and caterpillars and as well as soil borne insects like white grub, termite and alike are also disclosed.

U.S. Pat. No. 5,413,784 describes a novel and useful biopesticides with activity against insect pests such as boll weevil, sweet potato whitefly, and cotton fleahopper. The biopesticides comprises an entomopathogenic fungus having virulence against targets insect pests. A preferred fungus is Beauveria bassiana ATCC-7040.

U.S. Pat. No. 5,939,065 describes a entomopathogenic fungus having virulence against insects of the grasshopper family. The fungus is a strain of Beauveria bassiana—specifically B. bassiana BbGHA1991, ATTC 72450.

U.S. Pat. No. 5,516,513 describes an agricultural formulation of a virulent isolate of Beauveria bassiana, which has the characteristics of B. bassiana ATCC 74040, can be used to effectively control lepidopterous insects. This fungal strain has been found to be active against the egg stage of lepidopterans. Activity against the larval stages of lepidopterans is also shown.

U.S. Pat. No. 7,241,612 describes a biopesticidal composition for controlling insects (e.g., pecan weevils, the diaprepes root weevil, fall armyworm, fire ants), containing an agriculturally acceptable carrier and an effective insect (e.g., pecan weevils, the diaprepes root weevil, fall armyworm, fire ants) biopesticidal amount of a fungus selected from the group consisting of Beauveria bassiana having the identifying characteristics of Beauveria bassiana NRRL 30593, Metarhizium anisopliae having the identifying characteristics of Metarhizium anisopliae NRRL 30594, Beauveria bassiana having the identifying characteristics of Beauveria bassiana NRRL 30601, Beauveria bassiana having the identifying characteristics of Beauveria bassiana NRRL 30600, or mixtures thereof. Also, a method for controlling insects (e.g., pecan weevils, the diaprepes root weevil, fall armyworm, fire ants), involving applying an effective insect biopesticidal amount of the composition to the insects or to the plants, areas or substrates infested with the insects.

While many solutions exists to control a variety of insect pest a need exists to control pests, and in particular settings, bed bugs. Solutions such as chemical pesticides are frequently used to control pests in agricultural industries and to control bed bugs and bed bug associated diseases in commercial hotels, motels, dormitories, hostels, and residential housing; however, new solutions for controlling pests, in particular, bed bugs are desirable.

### SUMMARY OF THE INVENTION

Disclosed herein are compositions and methods which offer a unique and practical approach to controlling infestations of arthropod pests across a variety of industries (e.g., the agricultural industry) and in particular embodiment controlling infestations of bed bugs, in the lodging industry (e.g., hotels, motels, dormitories, hostels, etc.) as well as in the residential home by taking advantage of fungal pesticides which can be horizontally transmitted across pest populations. Horizontal transmission across the pest population will propagate infection by the fungal pesticides to not only adult pests but pests of all life stages (e.g., eggs, nymphs, instars, adults, etc.) and resolve the infestation. Horizontal transmission across a pest population may occur with social pests (e.g., ants), semi-social pests (e.g., wasps), and gregarious pests (e.g., bed bugs) which aggregate in confined harborages.

The fungal pesticide compositions used in the embodiments of the invention comprise at least two fungal pesticides, preferably disposed in and/or on a carrier. Particular fungal pesticides include entomopathogenic fungi, including species of Metarhizium and/or Beauveria. Preferably, the fungal pesticides are horizontally transmissible across a population of pests.

In a particular embodiment, the composition will comprise a carrier, a first fungal pesticide and a second fungal pesticide, wherein the first fungal pesticide is a strain of Metarhizium anisopliae and the second fungal pesticide is a strain of Beauveria bassiana. In an embodiment, the first fungal pesticide and the second fungal pesticide will control target pests at different life stages. In a particular embodiment, the first fungal pesticide and the second fungal pesticide will control pests at the egg stage, the nymph stage, the instar stage, and the adult stage. In an embodiment, the first fungal pesticide will control pests at the egg stage and the second fungal pesticide will control pests at the adult stage.

Chemical pesticides may also be used in combination with fungal pesticides, including as part of the same composition or through a separate treatment process. In one embodiment, the chemical pesticide employed, will not immediately kill the target pest to ensure the fungal pesticide can be subsequently horizontally transmitted across the pest population. In another embodiment, the chemical pesticide employed, will immediately kill the target pest and the fungal pesticide will be horizontally transmitted across the pest population by surviving pests to pests at all life stages. The fungal pesticide compositions described herein may be applied directly to a pest habitat or via a pest control device.

Disclosed herein are also methods for controlling pests such as plant pests and, in particular embodiments, human pests such as bed bugs. In an embodiment, the method comprises contacting one or more pests with a first fungal pesticide and a second fungal pesticide. The first and second fungal pesticides may be applied sequentially or simultaneously. In an embodiment, the first fungal pesticide controls one or more pests at the egg stage, the nymph stage, the instar stage, the adult stage, or combinations thereof. In another embodiment, the second fungal pesticide controls the one or more pests at the egg stage, the nymph stage, the instar stage, the adult stage, or combinations thereof. In a particular embodiment, the first fungal pesticide controls the one or more pests at the egg stage and the second fungal pesticide controls the one or more pests at the adult stage. In another embodiment, the first fungal pesticide is a strain of Metarhizium sp. and the second fungal pesticide is a strain of Beauveria sp. In still another embodiment, first fungal pesticide is a strain of Metarhizium anisopliae and the second fungal pesticide is a strain of Beauveria bassiana. In still a further embodiment, the first fungal pesticide is a strain of Metarhizium anisopliae F52. In still a further embodiment, the first fungal pesticide is a strain of Metarhizium anisopliae F52 and the second fungal pesticide is the strain Beauveria bassiana ATCC 74040. In still a further embodiment, the first fungal pesticide is a strain of Metarhizium anisopliae F52 and the second fungal pesticide is the strain Beauveria bassiana ATCC 74250. In still yet a further embodiment, the first fungal pesticide, the second fungal pesticide, or both the first fungal pesticide and the second fungal pesticide are in a spore form.

### DETAILED DESCRIPTION OF THE INVENTION

The disclosed embodiments relate to compositions and methods for controlling infestations of arthropod pests, such as plant pests, and particularly, infestations of bed bugs in human dwellings.

### Definitions:

As used herein, the singular forms “a”, “an” and “the” are intended to include the plural forms as well, unless the context clearly indicates otherwise.

As used herein, the term “fungal pesticide” means a fungal organism, whether in a vegetative state or a dormant state (e.g., spore), that is pathogenic to a target pest, such as, an insect, Acari, or a nematode.

As used herein, the term “entomopathogenic” means that the fungal pesticide is pathogenic to at least one target insect. As used herein, “entomopathogenic fungus” is a fungus that is capable of attacking, infecting, killing, disabling, causing disease, and/or causing injury to an insect, and is thus able to be used in the control insect infestation by adversely affecting the viability or growth of the target insect.

As used herein, the term “acaripathogenic” means that the fungal pesticide is pathogenic to at least one target Acari, such as, as mite or tick. As used herein, “acaripathogenic fungus” is a fungus that is capable of attacking, infecting, killing, disabling, causing disease, and/or causing injury to an Acari, and is thus able to be used in the control of Acari infestation by adversely affecting the viability or growth of the target Acari.

As used herein, the terms “spore” has its normal meaning which is well known and understood by those of skill in the art. As used herein, the term spore refers to a microorganism in its dormant, protected state.

As used herein in, a “cuticle degrading enzyme” is an enzyme that is able to at least partially degrade a cuticle of a pest, such as, the epicuticle and/or the procuticle. The exogenously applied cuticle degrading enzyme can increase the efficacy of the fungal pesticide by increasing the ability of the fungal pesticide to colonize and/or or bore through the pest's cuticle to reach the pest's body cavity.

As used herein, “exogenously applied” means that the cuticle degrading enzyme is applied independently (that is, as a separate ingredient) from the compositions disclosed herein and any enzyme produced by fungal pesticide.

The “exogenously applied” cuticle degrading enzyme is in the form of an “isolated” enzyme composition.

The term “isolated” means the enzyme is in a form or environment which does not occur in nature, that is, the enzyme is at least partially removed from one or more or all of the naturally occurring constituents with which it is associated in nature. Thus, although enzymes produced endogenously by the fungal pesticide will impact efficacy, an isolated enzyme does not encompass an enzyme endogenously produced by the fungal pesticide during treatment of a pest in the processes of the present invention. An isolated enzyme may be present in the form of a purified enzyme composition or a fermentation broth sample that contains the enzyme.

The term “pest” refers to any animal of the scientific classification (phylum) Arthropoda including Insecta, (e.g., bed bugs) and Arachnida, which includes, but is not limited to, mites, ticks, spiders, and other like invertebrates.

As used herein, the term “control” or “controlling” as in e.g., the phrase: the “control” of pests or pest populations, or “controlling” pests or pest populations, or as in the phrase: “controlling” bed bugs, refers to preventing infestation, reducing the population of already infested areas or organisms, killing the pest or of the population of pests, or elimination of the pest or population of pests as defined herein. Indeed, “control” or “controlling” as used herein refers to any indicia of success in prevention, killing, elimination, reduction or amelioration of a pest or pest population.

As used herein, the term “horizontally transmission” includes the transmission of an infectious agent (e.g., a bacteria, a fungus, or a virus, etc.) between members of the same species that are not of a parent-child relationship unless the transmission between a parent and child occurs through maternal surface contamination of an egg or eggs.

As used herein, the terms “life stage” or “life stages” are intended to refer to any of the developmental stages (e.g., eggs, nymphs, instars, adults, etc.) of any animal of the scientific classification (phylum) Anthropoda including insecta, (e.g., bed bugs) and arachnida, which includes but is not limited to, mites, ticks, spiders, and other like invertebrates.

As used herein, the terms “effective amount”, “effective concentration”, or “effective dosage” are defined as the amount, concentration, or dosage of the fungal pesticide sufficient to cause infection in the pest which will then lead to the controlling of pests. The actual effective dosage in absolute value depends on factors including, but not limited to, the mortality rate of the target pests relative to the rate at which the fungal pesticide is applied, synergistic or antagonistic interactions between the other active or inert ingredients which may increase or reduce the activity of the fungal pesticide, the inherent susceptibility of the life stage and species of pest, and the stability of the fungal pesticide in compositions. The “effective amount”, “effective concentration”, or “effective dosage” of the fungal pesticide may be determined, e.g., by a routine dose response experiment.

As used herein, “at least one biologically active ingredient” means biologically active ingredients (e.g., enzymes, other microorganisms, etc.) other than a fungal pesticide as described herein.

As used herein, the term “attractant” refers to any stimulus that elicits a positive directional response from a target pest to move, either directly or indirectly, towards the location of the stimulus.

As used herein, the term “carrier” refers to a suspension medium capable of supporting a fungal pesticide as described herein.

As used herein, a “non-aqueous component” refers to a compound comprising at least one carbon atom, has high or low volatility, and is in a liquid form at room temperature. Non-limiting examples of “non-aqueous components” include silicone fluids, mineral oils, isoparaffinic hydrocarbons, and the like.

As used herein, “a non-aqueous liquid” refers to a liquid containing one or more “non-aqueous components”.

As used herein, “non-aqueous gel” refers to a composition containing a non-aqueous liquid and at least one gelling agent.

As used herein, a “gelling agent” refers to any agent used in combination with the non-aqueous liquid to form the gels disclosed herein.

As used herein, the term “surfactant” refers to a molecule that belongs to a class of molecules having a hydrophilic group (or groups) and a hydrophobic group (or groups) that exhibit surface activity when the relative amounts of hydrophilic and hydrophobic parts are appropriate.

As used herein, the term “water soluble surfactant” refers to a surfactant that has solubility in water of more than 1% (on a weight/weight basis) at room temperature.

As used herein, the term “water insoluble surfactant” means a surfactant that has solubility in water of less than 1% (on a weight/weight basis) at room temperature.

As used throughout this specification, the terms “parts by weight” or “percentage weight” are used interchangeably in the specification wherein the weight percentages of each of the individual constituents are indicated in weight percent based on the total weight of the particular composition of which it forms a part.

As used herein, a “phase-stable gel” refers to a gel showing substantially no observable separation (e.g., substantially no separation, substantially low separation, or substantially no syneresis) over a temperature range of 1° C. to 60° C. and also with respect to at least one freeze-thaw cycle, such as, at least two, at least three, at least four, at least five or at least six freeze-thaw cycles.

As used herein, the term “shear-thinning gel” refers to gels in which the original viscosity decreases upon application of a shear stress and then returns to its original viscosity after removal of the shear stress.

As used herein, the term “shear-thinning viscosity” refers to the pseudo plastic-like property of a gel such that the gel upon application of a shear stress decreases in viscosity and flow significantly easier (e.g., flows more like water).

As used herein, the “yield value” refers to the force that must be applied to the carrier before any movement of the carrier occurs. In certain embodiments, the yield value of the carrier is greater than the force exerted (e.g., gravitational or buoyant) by the components (e.g., biologically-active ingredients, such as spores) causing the component to remain suspended in the carrier as defined herein.

As used herein, “homogeneously” or “uniformly” suspended (distributed) refers to the composition of the gel such that particles/ingredients of the gel (e.g., the at least one entomopathogenic fungus) do not significantly redistribute in the gels of the present invention (other than from diffusion) unless the force of gravity of buoyancy can exert a force greater than the yield stress (from yield value) for application. Diffusion of the biologically-active ingredients in the gels is generally homogenous, and therefore, does not (or does not substantially) contribute to non-uniformity in the gels.

### Compositions:

The fungal pesticide compositions used in the embodiments of the invention comprise at least one pesticide, preferably disposed in and/or on a carrier. In an embodiment the compositions comprise at least two (e.g., as in two or more, such as two, three, four, five, six, seven, eight, nine, ten, etc.) different fungal pesticides.

The fungal pesticides are transferable from the carrier to the body of the target pest (e.g., bed bugs, etc.). The fungal pesticides compositions described herein can be of any form so long as the composition is able to support the desired activity (effective amount) of the fungal pesticide, regardless of form (e.g., vegetative state or dormant state), and the composition can be applied to control a target pest. The carrier may be used to provide an environment to support the viability of the at least one fungus, including by providing the proper environmental conditions and protecting the fungal pesticide from harmful environmental conditions (e.g., excess oxygen, moisture and/or ultraviolet radiation, etc.). Unless the compositions are generated immediately prior to use, the carrier may be used to maintain the activity of the fungal pesticide during storage (e.g., in a container for the entire shelf-life of the formulated product). The carrier may also be used to maintain the activity of the fungal pesticide after the fungal pesticide compositions described throughout have been applied to the application surface. In particular embodiments, the carrier provides an environment such that the fungal pesticide will not have more than a 1-log loss of the original viable content (prior to including in a carrier) over at least a one year period.

In certain embodiments, the composition may be in the form of a gel, a foam, a solid (such as a powder, granule, particle, etc.), or a liquid.

The composition, when measuring relative to the carrier and the fungal pesticide, may be formed of 85.00 wt. % to 99.98 wt. % of the carrier. In another embodiment, there may be minor variances when measuring relative to the carrier and the fungal pesticide, and the composition may be formed of about 85.00 wt. % to about 99.98 wt. % of the carrier. In still another embodiment, the composition is formed of 85.00 wt. % to 95.00 wt. % of the carrier. In yet another embodiment, there may be minor variances when measuring relative to the carrier and the fungal pesticide and the composition may be formed of about 85.00 wt. % to about 95.00 wt. % of the carrier. In another embodiment, when measuring relative to the fungal pesticide and the carrier, the composition may be formed of 0.02 wt. % to 15.00 wt. % of the fungal pesticide. In another embodiment, there may be minor variances when measuring relative to the fungal pesticide and the carrier and the composition may be formed of about 0.02 wt. % to about 15.00 wt. % of the fungal pesticide. In still another embodiment, the composition is formed of 5.00 wt. % to 15.00 wt. % of the fungal pesticide. In yet another embodiment, there may be minor variances when measuring relative to the fungal pesticide and the carrier and the composition may be formed of about 5.00 wt. % to about 15.00 wt. % of the fungal pesticide.

### Carrier(s):

The carrier will have the correct values (and range of values) for rheological measurements (e.g., viscosity, yield value, storage modulus, and loss modulus) to allow the fungal pesticide to remain efficacious (e.g., able to be transferred to the body of the pest with a degree of lethality) and viable once formulated.

In one embodiment of the composition, the carrier may be a liquid(s) (e.g., aqueous or non-aqueous). In another embodiment of the composition, the carrier may be a non-aqueous liquid(s). The carrier may be a emulsifiable suspension. In another embodiment, the emulsifiable suspension is an emulsifiable concentrate. In at least one embodiment, the carrier is a non-aqueous liquid(s) carrier as certain pests, bed bugs in particular, are hydrophobic, and therefore, have a relatively low critical surface tension. In using a non-aqueous liquid(s) as a carrier, it is envisioned that the lower surface tension of non-aqueous liquid(s) (e.g., silicone oils, etc.) will make it more likely that the composition will adhere to the body of the bed bugs.

The non-aqueous liquid(s) may be a biodegradable non-aqueous liquid(s). The non-aqueous liquid(s) may be a “Low Vapor Pressure Volatile Organic Compounds (LVP-VOC),” which is a chemical “compound” or “mixture of compounds” containing (1) a vapor pressure less than 0.1 mm Hg at 20° C., (2) composed of chemical compounds with more than 12 carbon atoms and/or (3) a boiling point greater than 216 ° C. See the definition of LVP-VOC provided by the California Air Resources Board (CARB). The non-aqueous liquid(s) may be a biodegradable LVP-VOC non-aqueous liquid(s). Non-limiting examples of non-aqueous liquids suitable as a carrier for the compositions described herein include silicone oils, mineral oils, hexylene glycol, glycerol, linoleic acid, oleic acid, and any combination thereof. An example of a commercial mineral oil includes BRITOL 50 (available from Sonneborn, Inc., Mahwah, N.J.), and an example of a silicone oil is DM Fluid 100 CS (available from Shin-Etsu Chemical Co., LtD., Tokyo, Japan).

In another embodiment of the composition, the carrier may be a gel comprising a liquid(s) (e.g., aqueous or non-aqueous) and a gelling agent(s). The gel can be formed using methods known to those skilled in the art. The gel may be a phase-stable gel. In one embodiment, the phase-stable gel shows substantially no observable separation (e.g., substantially no separation, substantially low separation, or substantially no syneresis) over a temperature range of 1° C. to 60° C. In another embodiment, the phase-stable gel shows substantially no observable separation (e.g., substantially no separation, substantially low separation, or substantially no syneresis) over a temperature range of 5° C. to 45° C. In particular embodiments, separation or syneresis (e.g., occurring during shipping or storage) can be substantially eliminated when the gel is shaken or another moderate force (e.g., stirring), is applied by a user. In one embodiment, the gel may be formed by high shear mixing (e.g., for laboratory-scale preparations in a blender, or for commercial-scale preparations in, for example, a high shear in line mixer and optionally using a high shear pump) of the liquid(s) and gelling agent(s).

In one embodiment of the carrier, when measuring relative to the liquid(s) and the gelling agent(s), the carrier may be a gel formed of 80.00 wt. % to 99.99 wt. % of the liquid(s). In yet another embodiment, there may be minor variances when measuring relative to the liquid(s) and the gelling agent(s) and the composition may be formed of about 80.00 wt. % to about 99.99 wt. % of the liquid(s). In another embodiment, when measuring relative to the gelling agent(s) and the liquid(s), the carrier may be a gel formed of 0.01 wt. % to 20.00 wt. % of the gelling agent(s). In still another embodiment, there may be minor variances when measuring relative to the gelling agent(s) and the liquid(s) and the composition may be formed of about 0.01 wt. % to about 20.00 wt. % of the gelling agent(s).

In still another embodiment, the carrier is a non-aqueous gel comprising a non-aqueous liquid(s) and a gelling agent(s). In an embodiment, the carrier comprises a non-aqueous liquid(s) as certain pests, bed bugs in particular, are hydrophobic, and therefore, have a relatively low critical surface tension. In using a carrier comprising a non-aqueous liquid(s), a lower surface tension of non-aqueous liquid(s) (e.g., silicone oils, etc.) will make it more likely that the composition will adhere to the body of the bed bugs.

The non-aqueous liquid(s) of the gel may be a biodegradable non-aqueous liquid(s). The non-aqueous liquid(s) of the gel may be a “Low Vapor Pressure Volatile Organic Compounds (LVP-VOC),” which is a chemical “compound” or “mixture of compounds” containing (1) a vapor pressure less than 0.1 mm Hg at 20° C., (2) composed of chemical compounds with more than 12 carbon atoms and/or (3) a boiling point greater than 216° C. See the definition of LVP-VOC provided by the California Air Resources Board (CARB). In another embodiment, the non-aqueous liquid(s) of the gel may be a biodegradable LVP-VOC non-aqueous liquid(s). Non-limiting examples of non-aqueous liquids suitable for the carrier of the compositions described herein include silicone oils, mineral oils, hexylene glycol, glycerol, linoleic acid, oleic acid, and any combination thereof. An example of a commercial mineral oil includes BRITOL 50 (available from Sonneborn, Inc., Mahwah, N.J.), and an example of a silicone oil is DM Fluid 100 CS (available from Shin-Etsu Chemical Co., LtD., Tokyo, Japan.

The gelling agent of the gel may be any agent capable of dissolving in the liquid phase as a colloid mixture to form a weakly cohesive internal structure. In one embodiment, the gelling agent is a polymer. Non-limiting examples of polymers that may be used as gelling agents include polyvinyl acetate, polyvinyl alcohols with different degrees of hydrolysis, polyvinylpyrrolidones, polyacrylates, acrylate-, polyol- or polyester-based paint system binders which are soluble or dispersible in water, moreover copolymers of two or more monomers such as acrylic acid, methacrylic acid, itaconic acid, maleic acid, fumaric acid, maleic anhydride, vinylpyrrolidone, ethylenically unsaturated monomers such as ethylene, butadiene, isoprene, chloroprene, styrene, divinylbenzene, ot-methylstyrene or p-methylstyrene, further vinyl halides such as vinyl chloride and vinylidene chloride, additionally vinyl esters such as vinyl acetate, vinyl propionate or vinyl stearate, moreover vinyl methyl ketone or esters of acrylic acid or methacrylic acid with monohydric alcohols or polyols such as methyl acrylate, methyl methacrylate, ethyl acrylate, ethylene methacrylate, lauryl acrylate, lauryl methacrylate, decyl acrylate, N,N-dimethylamino-ethyl methacrylate, 2-hydroxyethyl methacrylate, 2-hydroxypropyl methacrylate or glycidyl methacrylate, furthermore diethyl esters or monoesters of unsaturated dicarboxylic acids, furthermore (meth)acrylamido-N-methylol methyl ether, amides or nitriles such as acrylamide, methacrylamide, N-methylol(meth)acrylamide, acrylonitrile, methacrylonitrile, and also N-substituted maleiraides and ethers such as vinyl butyl ether, vinyl isobutyl ether or vinyl phenyl ether, and combinations thereof. In another embodiment, the gelling agents which may be used include hydrophobically-modified clays (e.g., sodium montmorillonite where exchangeable sodium ions are replaced with organic cationic molecules, such as, alkylamines), surface modified silicas, fumed silicas (e.g., untreated or surface-treated), and combinations thereof. An example of a commercially-available fumed silica is CAB-O-SIL M-5 (available from Cabot Corporation, Tuscola, Ill.).

In another embodiment, the non-aqueous gel is a phase-stable non-aqueous gel, and in a particular embodiment, the non-aqueous phase-stable gel shows substantially no observable separation (e.g., substantially no separation, substantially low separation, or substantially no syneresis) over a temperature range of 1° C. to 60° C. In another embodiment, the non-aqueous phase-stable gel shows substantially no observable separation (e.g., substantially no separation, substantially low separation, or substantially no syneresis) over a temperature range of 5° C. to 45° C. In particular embodiments, separation or syneresis (e.g., occurring during shipping or storage) can be substantially eliminated when the gel is shaken or another moderate force (e.g., stirring), is applied by a user.

In another embodiment, the carrier can be a shear-thinning gel. In yet another embodiment, the non-aqueous gel described herein can be a shear-thinning gel. In embodiments where the carrier of the composition is a non-aqueous shear-thinning gel, the non-aqueous shear-thinning gel may be capable of producing a foam for application to devices and/or external surfaces, as well as to cracks, crevices, or any other surface that is otherwise desirable for treatment with the compositions provided throughout. In certain embodiments when the non-aqueous shear-thinning gel is applied to a surface as a foam, the shear-thinning properties of the non-aqueous gel are such that the foam will return to its gel state and remain on the surface to which it was applied.

In one embodiment, the non-aqueous gel may be formed by high shear mixing (e.g., for laboratory-scale preparations in a blender, or for commercial-scale preparations in, for example, a high shear in line mixer and optionally using a high shear pump) of the non-aqueous liquid(s) and gelling agent(s). In one embodiment of the carrier, when measuring relative to the non-aqueous liquid(s) and the gelling agent(s), the carrier may be a gel formed of 80.00 wt. % to 99.99 wt. % of the non-aqueous liquid(s). In yet another embodiment, there may be minor variances when measuring relative to the non-aqueous liquid(s) and the gelling agent(s) and the carrier may be formed of about 80.00 wt. % to about 99.99 wt. % of the non-aqueous liquid(s). In another embodiment the carrier is a non-aqueous gel formed of 95.00 wt. % to 99.00 wt. % of the non-aqueous liquid(s). In yet another embodiment, there may be minor variances when measuring relative to the non-aqueous liquid(s) and the gelling agent(s) and the carrier may be formed of about 95.00 wt. % to about 99.99 wt. % of the non-aqueous liquid(s). In another embodiment, when measuring relative to the gelling agent(s) and the non-aqueous liquid(s), the carrier may be a non-aqueous gel formed of 0.01 wt. % to 20.00 wt. % of the gelling agent(s). In still another embodiment, there may be minor variances when measuring relative to the gelling agent(s) and the non-aqueous liquid(s) and the carrier may be formed of about 0.01 wt. % to about 20.00 wt. % of the gelling agent(s). In yet another embodiment the carrier is a non-aqueous gel formed of 1.00 wt. % to 5.00 wt. % of the gelling agent(s). In still another embodiment, there may be minor variances when measuring relative to the gelling agent(s) and the non-aqueous liquid(s) and the carrier may be formed of about 1.00 wt. % to about 5.00 wt. % of the gelling agent(s).

In certain embodiments, the non-aqueous shear-thinning gel may further require other additives known to those skilled in the art (e.g., propulsion gas(es), etc.) if the non-aqueous shear-thinning gel is to be applied as a foam. In embodiments where propulsion gas(es) are used, the propulsion gas(es) may be used to provide sufficient shearing force to the non-aqueous shear-thinning gel such that the viscosity of the gel would decrease, allowing the composition to be applied and/or delivered as a foam.

### Surfactants

In one embodiment, one or more appropriate surfactants known to those skilled in the art may be added to the non-aqueous shear-thinning gel to produce a foam. Non-limiting examples of surfactants that may be used are included in the “Surfactants” section provided herein.

The carriers described herein may include one or more anionic surfactants, one or more nonionic surfactants, or a combination of one or more anionic surfactants or more or more nonionic surfactants. This section provides a number of non-limiting examples of surfactants which may be suitable for use with the carriers described herein. The different kind of surfactants are chosen and comprised in certain ratios in order to obtain a carrier with certain properties (e.g., application of a carrier as a foam, etc.).

Anionic Surfactants

The carriers described herein may comprise at least one or more anionic surfactants. The anionic surfactant(s) may be either water soluble anionic surfactants, water insoluble anionic surfactants, or a combination of water soluble anionic surfactants and water insoluble anionic surfactants.

Non-limiting examples of water soluble anionic surfactants include alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-N-alkyltaurates, alkyl carboxylates, or a combination thereof.

Nonionic Surfactants

The carriers described herein may comprise at least one or more nonionic surfactants. The nonionic surfactant(s) may be either water soluble nonionic surfactants, water insoluble nonionic surfactants, or a combination of water soluble nonionic surfactants and water insoluble nonionic surfactants.

Water Insoluble Nonionic Surfactants

Non-limiting examples of water insoluble nonionic surfactants include alkyl and aryl: glycerol ethers, glycol ethers, ethanolamides, sulfoanylamides, alcohols, amides, alcohol ethoxylates, glycerol esters, glycol esters, ethoxylates of glycerol ester and glycol esters, sugar-based alkyl polyglycosides, polyoxyethylenated fatty acids, alkanolamine condensates, alkanolamides, tertiary acetylenic glycols, polyoxyethylenated mercaptans, carboxylic acid esters, polyoxyethylenated polyoxyproylene glycols, sorbitan fatty esters, or combinations thereof. Also included are EO/PO block copolymers (EO is ethylene oxide, PO is propylene oxide), EO polymers and copolymers, polyamines, and polyvinylpynolidones.

In one embodiment, the carriers described herein comprise at least one or more ethoxylates. In another embodiment the one or more ethoxylates comprise at least one or more alcohol ethoxylates. Alcohol ethoxylates have the formula: RO(CH₂CH₂O)ₙH, where R is the hydrocarbon chain length and n is the average number of moles of ethylene oxide. In yet another embodiment, the carriers described herein comprise at least one alcohol ethoxylate that is a linear primary, or secondary, or branched alcohol ethoxylate where R has a chain length from C9 to C16 and n ranges from 0 to 5. In another embodiment, the alcohol ethoxylate is a linear primary, or secondary or branched alcohol ethoxylate having the formula: RO(CH₂CH₂O)ₙH, wherein R has a chain length of C9-11 and n is 2.7. In still another embodiment, the carriers described herein comprise more than one water insoluble surfactant comprise water insoluble surfactants of substantially the same carbon chain length.

In at least one embodiment, the carriers described herein comprise at least one water insoluble nonionic surfactant selected from the group consisting of Tomadol® 91-2.5, Tomadol® 23-1, Tomadol® 23-3, Span™ 20, Span™ 40, Span™ 60, Span™ 65, Span™ 80, Span™ 85, and combinations thereof.

Water Soluble Nonionic Surfactants

Non-limiting examples of water soluble nonionic surfactants include sorbitan fatty acid alcohol ethoxylates and sorbitan fatty acid ester ethoxylates. In one embodiment, the carrier comprises at least one water soluble nonionic surfactant that is a linear primary, or secondary or branched alcohol ethoxylate having the formula: RO(CH₂CH₂O)ₙH, wherein R is the hydrocarbon chain length and n is the average number of moles of ethylene oxide. In an embodiment, R can be a linear primary, or secondary, or branched alcohol ethoxylates having a hydrocarbon chain length in the range from C9 to C16 and n ranges from 6 to 13. In another embodiment the carrier comprises at least one alcohol ethoxylate where R is linear C9-C11 hydrocarbon chain length, and n is 6. In still another embodiment, when the carriers described herein comprise more than one water soluble surfactant, the water soluble surfactants are of substantially the same carbon chain length.

In one embodiment, the carriers described herein comprise at least one water soluble nonionic surfactant selected from the group consisting of Tomadol® 9-11, Tomadol® 23-7, Tomadol® 91-6, and combinations thereof.

In another embodiment, the carriers described herein comprise at least one sorbitan fatty acid ester ethoxylate. In still another embodiment, the carriers described herein comprise at least one sorbitan fatty acid ester ethoxylate selected from the group consisting of Tween® 20, Tween® 21, Tween® 40, Tween® 60, Tween® 80, and combinations thereof.

In still another embodiment, the carriers described herein comprise at least one alcohol ethoxylate, at least one sorbitan fatty acid ester ethoxylate, or a combination thereof. In still another embodiment, the carriers described herein comprise at least one water soluble nonionic surfactant selected from the group consisting of Tomadol® 9-11, Tomadol® 23-7, Tomadol® 91-6, Tween® 20, Tween® 21, Tween® 40, Tween® 60, Tween® 80, and combinations thereof.

Combination of Nonionic Surfactants

In one embodiment, the carriers described herein comprise at least one or more nonionic surfactants. In one embodiment, the carriers comprise at least one water insoluble nonionic surfactant and at least one water soluble nonionic surfactant. In still another embodiment, the carriers comprise a combination of nonionic surfactants having hydrocarbon chains of substantially the same length.

Other Surfactants

In another embodiment, the carriers described herein may also comprise silicone-based antifoams used as surfactants in silicone-based and mineral-oil based antifoams.

In another embodiment, the carriers described herein may also comprise alkali metal salts of fatty acids (e.g., water soluble alkali metal salts of fatty acids and/or water insoluble alkali metal salts of fatty acids) of greater than 10 carbons in length. In an embodiment, carriers comprising alkali metal salts of fatty acids comprise carbon chains greater than or equal to 18 carbons in length. In still another embodiment, carriers comprising alkali metal salts of fatty acids comprise carbon chains greater than or equal to 20 carbons in length.

### Fungal Pesticide(s):

Any suitable fungal pesticide may be used, based on the targeted pest. Fungal pesticides are well known in the art. In one embodiment, the fungal pesticide may be one or more entomopathogenic fungi, one or more acaripathogenic fungi, or a combination thereof. In another embodiment, the fungal pesticide is capable of horizontal transmission across a population of pests known to exhibit social behavior, semi-social behavior, or which are gregarious pests (e.g., bed bugs). In another embodiment, the fungal pesticide is capable of horizontal transmission across a population of pests, e.g., bed bugs. In another embodiment, the fungal pesticide will control target pests at different life stages. In a particular embodiment, the fungal pesticides will control pests at the egg stage, the nymph stage, the instar stage, and the adult stage. In another embodiment, the fungal pesticides will control bed bugs at the egg stage and the adult stage. In yet another embodiment, the fungal pesticide is capable of horizontal transmission across a population of bed bugs and will control bed bugs at various life stages. In yet still another embodiment, the fungal pesticide is capable of horizontal transmission across a population of plant pests and will control plant pests at various life stages.

The first and/or second fungal pesticide will, in particular embodiments, be present in an effective amount, such as a quantity between 1×10² and 1×10¹² CFU/g, between 1×10⁵ and 1×10¹⁰ CFU/g, or between 1×10⁶ and 1×10⁹ CFU/g. In another embodiment, the first and/or second fungal pesticide may be present in quantities substantially near or at the quantities provided, such as between about 1×10² and about 1×10¹² CFU/g, between about 1×10⁵ and about 1×10¹⁰ CFU/g, or between about 1×10⁶ and about 1×10⁹ CFU/g.

Non-limiting examples of fungal pesticides that may be used in the compositions disclosed herein are described in McCoy, C. W., Samson, R. A., and Coucias, D. G. “Entomogenous fungi. In “CRC Handbook of Natural Pesticides. Microbial Pesticides, Part A. Entomogenous Protozoa and Fungi.” (C. M. Inoffo, ed.), (1988): Vol. 5, 151-236; Samson, R. A., Evans, H.C., and Latge', J. P. “Atlas of Entomopathogenic Fungi.” (Springer-Verlag, Berlin) (1988); and deFaria, M. R. and Wraight, S. P. “Mycoinsecticides and Mycoacaricides: A comprehensive list with worldwide coverage and international classification of formulation types.” Biol. Control (2007), doi: 10.1016/j.biocontrol.2007.08.001.

In one embodiment, non-limiting examples fungal pesticides that may be used in the compositions disclosed herein include species of Coelomycidium, Myiophagus, Coelemomyces, Lagenidium, Leptolegnia, Couchia, Sporodiniella, Conidiobolus, Entomophaga, Entomophthora, Erynia, Massospora, Meristacrum, Neozygites, Pandora, Zoophthora, Blastodendrion, Metschnikowia, Mycoderma, Ascophaera, Cordyceps, Torrubiella, Nectria, Hypocrella, Calonectria, Filariomyces, Hesperomyces, Trenomyces, Myriangium, Podonectria, Akanthomyces, Aschersonia, Aspergillus, Beauveria, Culicinomyces, Engyodontium, Fusarium, GibeHula, Hirsutella, Hymenostilbe, Isaria, Metarhizium, Nomuraea, Paecilomyces, Paraisaria, Pleurodesmospora, Polycephalomyces, Pseudogibellula, Sorosporella, Stillbella, Tetranacrium, Tilachlidium, Tolypocladium, Verticillium, Aegerita, Filobasidiella, Septobasidium, Uredinella, and combinations thereof. Non-limiting examples of species of fungal pesticides include Trichoderma hamatum, Trichoderma hazarium, Alternaria cassiae, Fusarium lateritum, Fusarium solani, Lecanicillium lecanii, Aspergillus parasiticus, Metarhizium anisopliae, and Beauveria bassiana. In an embodiment, the compositions disclosed herein may include any of the fungal pesticides provided above, including any combination thereof. In another embodiment, the fungal pesticide(s) is stable so that the fungal pesticide(s) retains a sufficient effective amount of activity when used. Methods for producing stabilized fungal organisms are known in the art. In one embodiment, the fungal pesticide organism(s) is present in the composition in the form of a stable spore(s).

In one embodiment, the composition comprises at least one fungal pesticide from the genus Metarhizium spp., such as, Metarhizium anisopliae. In at least one embodiment, the fungal pesticide comprises the strain Metarhizium anisopliae strain F52. In another embodiment, the compositions comprise spores of Metarhizium anisopliae. In still another embodiment, the compositions comprise spores of the strain Metarhizium anisopliae F52. The name of the species Metarhizium anisopliae of the strain Metarhizium anisopliae F52 has recently been changed to Metarhizium brunneum, and thus, may be referred to in the art under both names.

In one embodiment, the composition comprises at least one fungal pesticide from the genus Beauveria spp., such as, for example, Beauveria bassiana. In at least one embodiment, the compositions comprise spores of Beauveria bassiana. In another embodiment, the fungal pesticide comprises the strain Beauveria bassiana strain ATCC-74040. In still another embodiment, the compositions comprise spores of the strain Beauveria bassiana strain ATCC-74040. In a further embodiment, the fungal pesticide comprises the strain Beauveria bassiana strain ATCC-74250. In still another embodiment, the compositions comprise spores of the strain Beauveria bassiana strain ATCC-74250.

The composition as described herein may comprise a combination of fungi. In one embodiment, the composition comprises two or more fungal pesticides that are different strains of the same species. In another embodiment, the composition comprises at least two different fungal pesticides that are strains of different species. In an embodiment, the composition comprises at least one fungal pesticide from the genus Metarhizium spp. and at least one fungal pesticide from the genus Beauveria spp. In another embodiment, the compositions comprise spores of Metarhizium spp. and Beauveria spp. In a particular embodiment, the fungal pesticide comprises Metarhizium anisopliae and Beauveria bassiana. In another embodiment, the compositions comprise spores of Metarhizium anisopliae and Beauveria bassiana. In a further embodiment the fungal pesticide comprises the strain Metarhizium anisopliae F52 and the strain Beauveria bassiana ATCC-74040. In yet another embodiment, the compositions comprise spores of the strain Metarhizium anisopliae F52 and the strain Beauveria bassiana ATCC-74040. In still another embodiment the fungal pesticide comprises the strain Metarhizium anisopliae F52 and the strain Beauveria bassiana ATCC-74250. In yet another embodiment, the compositions comprise spores of the strain Metarhizium anisopliae F52 and the strain Beauveria bassiana ATCC-74250. In still yet another embodiment the fungal pesticide comprises the strain Metarhizium anisopliae F52, the strain Beauveria bassiana ATCC-74040, and the strain Beauveria bassiana ATCC-74250. In yet another embodiment, the compositions comprise spores of the strain Metarhizium anisopliae F52, the strain Beauveria bassiana ATCC-74040, and the strain Beauveria bassiana ATCC-74250.

The fungal pesticide may be produced in a liquid culture media or a solid culture media fermentation process. The media may have high carbon and nitrogen concentrations to facilitate higher yields. Not-limiting examples of suitable nitrogen sources include hydrolyzed casein, yeast extract, hydrolyzed soy protein, hydrolyzed cottonseed protein, and hydrolyzed corn gluten protein. Not-limiting examples of suitable carbon sources include carbohydrates, including glucose, fructose, and sucrose, and glycerol and/or grains such as rice or barley.

Fermentation processes may be conducted using conventional fermentation processes, such as, aerobic liquid-culture techniques, shake flask cultivation, and small-scale or large-scale fermentation (e.g., continuous, batch, fed-batch, solid state fermentation, etc.) in laboratory or industrial fermentors, and such processes are well known in the art. Notwithstanding the production process used to produce the fungal organism, it is envisioned that the fungal pesticide may be used as a pesticide directly from the culture medium or subject to purification and/or further processing steps (e.g., a drying process). In one embodiment, following fermentation, the fungal organism may be recovered using conventional techniques (e.g., by filtration, centrifugation, etc.). The fungal organism may alternatively be dried (e.g., air-drying, freeze drying, or spray drying to a low moisture level, and storing at a suitable temperature, e.g., room temperature).

In a particular embodiment, the fungal pesticide composition is horizontally transmissible across a population of pests, e.g., bed bugs, and will be used to control pests, e.g., bed bugs, at various life stages. The fungal pesticide composition comprises at least one fungal pesticide from the genus Metarhizium spp. and/or at least one fungal pesticide from the genus Beauveria spp. In another embodiment, the fungal pesticide comprises Metarhizium anisopliae and/or Beauveria bassiana.

### Optional Ingredients:

The fungal pesticide compositions described herein may further comprise one or more optional ingredients that are physically and/or chemically compatible with the compositions embodied herein. Non-limiting optional ingredients include biologically active ingredients, chemical pesticides and biopesticides (e.g., insecticide, including other bioinsecticides), synergists, desiccants, insect growth regulators, electrostatic carriers, attractants surfactants, rheology modifying agents (e.g., thickeners, etc.), preservatives, colorants, opacifiers, fragrances, fillers, pH adjusting agents, stabilizers, builders, buffers, antioxidants, oxygen scavenger, water absorbing agents, foams, humectants, wetting agents UV protectants, fillers, solvents, nutritive additives, and combinations thereof. Such ingredients are known to those skilled in the art.

### Biologically Active Ingredients

The fungal pesticide compositions described herein may optionally include one or more biologically active ingredients as described herein, other than the fungal pesticides described herein. Non-limiting examples of biologically active ingredients include enzymes, microorganisms other than a fungal pesticide, and metabolites as described herein.

Enzymes:

In at least one embodiment, the compositions described herein may optionally comprise one or more enzymes. The compositions described herein may comprise at least one cuticle degrading enzymes. Cuticle degrading enzymes are well known in the art, and include both naturally occurring (wild-type) enzymes and variant (modified by humans) enzymes. Non-limiting examples of cuticle degrading enzymes include proteases, peptidases, chitinases, chitosanase, cutinases, and lipases. In an embodiment, the composition optionally comprises at least one cuticle degrading enzyme selected from the group consisting of protease, peptidase, chitinase, chitosanase, lipase, cutinase, and any combination thereof. In another embodiment the at least one cuticle degrading enzyme is a protease. In another embodiment the at least one cuticle degrading enzyme is a chitinase. In yet another embodiment the at least one cuticle degrading enzyme is a lipase. In still another embodiment the at least one cuticle degrading enzyme is a cutinase.

In at least one embodiment the compositions described herein comprise a combination of at least two cuticle degrading enzymes (e.g., two cuticle degrading enzymes, three cuticle degrading enzymes, four cuticle degrading enzymes, five cuticle degrading enzymes, etc.). In one embodiment, the compositions described herein comprise a combination of at least two different types of enzymes (e.g., a protease and chitinase). In yet another embodiment, the compositions described herein comprise a combination of at least two of the same type of enzyme (e.g., at least two different proteases, etc.). In still another embodiment, the compositions described herein comprise a combination of at least three cuticle degrading enzymes (e.g., a protease, a chitinase, a lipase, etc.).

Enzymes described herein may possess one or more cuticle degrading activities. The cuticle degrading enzyme may be obtained from any suitable source. In embodiments, the cuticle degrading enzyme may be obtained from a microorganism (e.g., a bacterial source or a fungal source). In another embodiment, the cuticle degrading enzyme is the protease described in WO 89/06279. Commercial proteases may also be used, such as, e.g. the product SAVINASE (available from Novozymes A/S).

Enzymes described herein may also be isolated from an entomopathogenic fungus or an acaripathogenic fungus.

Non-limiting examples of cuticle degrading enzymes are described in Bagga, S., et al. “Reconstructing the diversification of subtilisins in the pathogenic fungus Metarhizium anisopliae.” Gene 324 (2004): 159-69; Bidochka, M. J. and M. J. Melzer. “Genetic polymorphisms in three subtilisin-like protease isoforms (Pr1A, Pr1B, and Pr1C) from Metarhizium strains.” Canadian Journal of Microbiology 46.12 (2000): 1138-44; Braga, G. U. L., R. Vencovsky, and C. L. Messias. “Estimates of genetic parameters related to chitinase production by the entomopathogenic fungus Metarhizium anisopliae.” Genetics and Molecular Biology 21.2 (1998): 171-77; Clarkson, J. M. “Molecular biology of fungi for the control of insects.” (1996): 123-35; Cole, S. C. J., A. K. Charnley, and R. M. Cooper. “Purification and partial characterization of a novel trypsin-like cysteine protease from Metarhizium-anisopliae.” FEMS Microbiology Letters 113.2 (1993): 189-96; Da Silva, M. V., et al. “Cuticle-induced endo/exoacting chitinase CHIT30 from Metarhizium anisopliae is encoded by an ortholog of the chi3 gene.” Research in Microbiology 156.3 (2005): 382-92; Dhar & Kaur, “Production of cuticle-degrading proteases by Beauveria bassiana and their induction in different media,” African Journal of Biochemistry Research, Vol. 4(3), 65-72 (2010); Fang, W. G., et al. “Expressing a fusion protein with protease and chitinase activities increases the virulence of the insect pathogen Beauveria bassiana.” Journal of Invertebrate Pathology 102.2 (2009): 155-59; Freimoser, F. M., et al. “Expressed sequence tag (EST) analysis of two subspecies of Metarhizium anisopliae reveals a plethora of secreted proteins with potential activity in insect hosts.” Microbiology-Sgm 149 (2003): 239-47; Gimenez-Pecci, MdIP, et al. “Characterization of mycoviruses and analyses of chitinase secretion in the biocontrol fungus Metarhizium anisopliae.” Current Microbiology 45.5 (2002): 334-39; Hu, G. and R. J. S. Leger. “A phylogenomic approach to reconstructing the diversification of serine proteases in fungi.” Journal of Evolutionary Biology 17.6 (2004): 1204-14; Hutwimmer, S., et al. “Algorithm-based design of synthetic growth media stimulating virulence properties of Metarhizium anisopliae conidia.” Journal of Applied Microbiology 105.6 (2008): 2026-34; Joshi, L., R. S. S. Leger, and D. W. Roberts. “Isolation of a cDNA encoding a novel subtilisin-like protease (Pr1B) from the entomopathogenic fungus, Metarhizium anisopliae using differential display-RT-PCR.” Gene (Amsterdam) 197.1-2 (1997): 1-8; Kim, H. K., et al. “Gene structure and expression of the gene from Beauveria bassiana encoding bassiasin I, an insect cuticle-degrading serine protease.” Biotechnology Letters 21.9 (1999): 777-83; Kim, J. S. “A novel biopesticide production: Attagel-mediated precipitation of chitinase from Beauveria bassiana SFB-205 supernatant for thermotolerance.” Applied Microbiology and Biotechnology 87.5 (2010): 1639-48; “Relation of aphicidal activity with cuticular degradation by Beauveria bassiana SFB-205 supernatant incorporated with polyoxyethylene-(3)-isotridecyl ether.” Journal of Microbiology and Biotechnology 20.3 (2010): 506-09; Kim, J. S., et al. “Influence of two FPLC fractions from Beauveria bassiana SFB-205 supernatant on the insecticidal activity against cotton aphid.” Biocontrol Science and Technology 20.1 (2010): 77-81; Kim, J. S., et al. “Correlation of the aphicidal activity of Beauveria bassiana SFB-205 supernatant with enzymes.” Fungal Biology 114.1 (2010): 120-28; Ko, H. J., et al. “Optimal production of protease from entomopathogenic fungus Beauveria bassiana.” Agricultural Chemistry and Biotechnology 39.6 (1996): 449-54; Ko, H. J., et al. “Purification and characterization of protease from entomopathogenic fungus Beauveria bassiana.” Agricultural Chemistry and Biotechnology 40.5 (1997): 388-94; Leal, S. C. M., et al. “Amplification and restriction endonuclease digestion of the Pr1 gene for the detection and characterization of Metarhizium strains.” Mycological Research 101.3 (1997): 257-65; Liang et al., “The crystal structures of two cuticle-degrading proteases from nematophagous fungi and their contribution to infection against nematodes,” The FASEB Journal, Vol. 24, 1391-1400, May 2010; Manalil, N. S., et al. “Comparative analysis of the Metarhizium anisopliae secretome in response to exposure to the greyback cane grub and grub cuticles.” Fungal Biology 114.8 (2010): 637-45; Mohanty, S. S., K. Raghavendra, and A. P. Dash. “Induction of chymoelastase (Pr1) of Metarhizium anisopliae and its role in causing mortality to mosquito larvae.” World Journal of Microbiology and Biotechnology 24.10 (2008): 2283-88; Mustafa, U. and G. Kaur. “Extracellular Enzyme Production in Metarhizium anisopliae Isolates.” Folia Microbiologica 54.6 (2009): 499-504; Nahar, P., V. Ghormade, and M. V. Deshpande. “The extracellular constitutive production of chitin deacetylase in Metarhizium anisopliae: possible edge to entomopathogenic fungi in the biological control of insect pests.” Journal of Invertebrate Pathology 85.2 (2004): 80-88; Ortiz-Urquiza, A., et al. “Effects of cultural conditions on fungal biomass, blastospore yields and toxicity of fungal secreted proteins in batch cultures of Metarhizium anisopliae (Ascomycota: Hypocreales).” Pest Management Science 66.7 (2010): 725-35; Paterson, I. C., et al. “Regulation of production of a trypsin-like protease by the insect pathogenic fungus Metarhizium-anisopliae.” FEMS Microbiology Letters 109.2-3 (1993): 323-27; “Specific induction of a cuticle-degrading protease of the insect pathogenic fungus Metarhizium-anisopliae.” Microbiology-Uk 140.Part 1 (1994): 185-89; “Partial characterization of specific inducers of a cuticle-degrading protease from the insect pathogenic fungus Metarhizium-anisopliae.” Microbiology-Uk 140.Part 11 (1994): 3153-59; Pinto, F. G., et al. “Genetic variation in the cuticle-degrading protease activity of the entomopathogen Metarhizium flavoviride.” Genetics and Molecular Biology 25.2 (2002): 231-34; Qazi, S. S. and G. G. Khachatourians. “Hydrated conidia of Metarhizium anisopliae release a family of metalloproteases.” Journal of Invertebrate Pathology 95.1 (2007): 48-59; Rangel, D. E. N., D. G. Alston, and D. W. Roberts. “Effects of physical and nutritional stress conditions during mycelial growth on conidial germination speed, adhesion to host cuticle, and virulence of Metarhizium anisopliae, an entomopathogenic fungus.” Mycological Research 112 (2008): 1355-61; Rodriguez, C. M L and B. CE Gongora. “Transformation of Beauveria bassiana Bb9205 with pr1A, pr1J, and stel genes of Metarhizium anisopliae and evaluation of the pathogenicity on the coffee berry borer.” REVISTA COLOMBIANA DE ENTOMOLOGIA 31.1 (2005): 51-58; Santi, L., et al. “Differential immunoproteomics enables identification of Metarhizium anisopliae proteins related to Rhipicephalus microplus infection.” Research in Microbiology 160.10 (2009): 824-28; Santi, L., et al. “Metarhizium anisopliae host-pathogen interaction: differential immunoproteomics reveals proteins involved in the infection process of arthropods.” Fungal Biology 114.4 (2010): 312-19; Sasaki, S. D., et al. “BmSI-7, a novel subtilisin inhibitor from Boophilus microplus, with activity toward Pr1 proteases from the fungus Metarhizium anisopliae.” Experimental Parasitology 118.2 (2008): 214-20; Screen, S. E., G. Hu, and R. J. Leger. “Transformants of Metarhizium anisopliae sf. anisopliae overexpressing chitinase from Metarhizium anisopliae sf. acridum show early induction of native chitinase but are not altered in pathogenicity to Manduca sexta.” Journal of Invertebrate Pathology 78.4 (2001): 260-66; Segers, R., et al. “The subtilisins of the invertebrate mycopathogens Verticillium chlamydosporium and Metarhizium anisopliae are serologically and functionally related.” FEMS Microbiology Letters 126.3 (1995): 227-31; Shah, F. A., C. S. Wang, and T. M. Butt. “Nutrition influences growth and virulence of the insect-pathogenic fungus Metarhizium anisopliae.” FEMS Microbiology Letters 251.2 (2005): 259-66; Small, C. L. and M. J. Bidochka. “Up-regulation of Pr1, a subtilisin-like protease, during conidiation in the insect pathogen Metarhizium anisopliae.” Mycological Research 109 (2005): 307-13; Smithson, S. L., et al. “Cloning and characterization of a gene encoding a cuticle-degrading protease from the insect pathogenic fungus Metarhizium anisopliae.” Gene (Amsterdam) 166.1 (1995): 161-65; St Leger, R. J. “The role of cuticle-degrading proteases in fungal pathogenesis of insects.” Canadian Journal of Botany 73.SUPPL. 1 SECT. E-H (1995): S1119-S1125; St Leger, R. J., M. J. Bidochka, and D. W. Roberts. “Characterization of a novel carboxypeptidase produced by the entomopathogenic fungus Metarhizium anisopliae.” Archives of biochemistry and biophysics 314.2 (1994): 392-98; “Germination triggers of Metarhizium anisopliae conidia are related to host species.” Microbiology (Reading) 140.7 (1994): 1651-60; St Leger, R. J., R. M. Cooper, and A. K. Charnley. “Distribution of chymoelastases and trypsin-like enzymes in five species of entomopathogenic deuteromycetes.” Archives of biochemistry and biophysics 258.1 (1987): 123-31; St Leger, R. J., L. Joshi, and D. W. Roberts. “Adaptation of proteases and carbohydrates of saprophytic, phytopathogenic and entomopathogenic fungi to the requirements of their ecological niches.” Microbiology (Reading, England) 143 (Pt 6) (1997): 1983-92; St Leger, R. J., J. O. Nelson, and S. E. Screen. “The entomopathogenic fungus Metarhizium anisopliae alters ambient pH, allowing extracellular protease production and activity.” Microbiology-Uk 145 (1999): 2691-99; St Leger, R. J. and D. W. Roberts. “Engineering improved mycoinsecticides.” Trends in Biotechnology 15.3 (1997): 83-85; St Leger, R. J., M. J. Bidochka, and D. W. Roberts. “Isoforms of the cuticle-degrading pr1 proteinase and production of a metalloproteinase by Metarhizium-anisopliae.” Archives of biochemistry and biophysics 313.1 (1994): 1-7; St Leger, R. J., R. M. Cooper, and A. K. Charnley. “Analysis of aminopeptidase and dipeptidylpeptidase iv from the entomopathogenic fungus Metarhizium-anisopliae.” Journal of General Microbiology 139.Part 2 (1993): 237-43; St Leger, R. J., et al. “Characterization and ultrastructural-localization of chitinases from Metarhizium-anisopliae, m-flavoviride, and Beauveria-bassiana during fungal invasion of host (manduca-sexta) cuticle.” Applied and Environmental Microbiology 62.3 (1996): 907-12; St Leger, R. J., L. Joshi, and D. Roberts. “Ambient pH is a major determinant in the expression of cuticle-degrading enzymes and hydrophobin by Metarhizium-anisopliae.” Applied and Environmental Microbiology 64.2 (1998): 709-13; St Leger, R. J., R. C. Staples, and D. W. Roberts. “Entomopathogenic isolates of Metarhizium-anisopliae, Beauveria-bassiana, and Aspergillus-flavus produce multiple extracellular chitinase isozymes.” Journal of Invertebrate Pathology 61.1 (1993): 81-84; St. Leger et al., “Production of Cuticle-degrading Enzymes by the Entomopathogen Metarhizium anisopliae during Infection of Cuticles from Calliphora vomitoria and Manduca sexta,” Journal of General Microbiology, 133, 1371-1382 (1987); St. Leger et al., “Cuticle-degrading Enzyme of Entomopathogenic Fungi: Regulation of Production of Chitonolytic Enzymes,” General Microbiology, 132, 1509-1517 (1987); St. Leger et al., “Cuticle-Degrading Enzymes of Entomopathogenic Fungi,” Synthesis in Culture on Cuticle, Journal of Invertebrate Pathology, 48, 85-95 (1986); Todorova, S. I., et al. “Heterogeneity of two Beauveria bassiana strains revealed by biochemical tests, protein profiles and bio-assays on Leptinotarsa decemlineata (Col.: Chrysomelidae) and Coleomegilla maculata lengi (Col.: Coccinellidae) larvae.” Entomophaga 39.2 (1994): 159-69; Valadares, M. C. C. and J. L. Azevedo. “Production of amylases and proteases by wild-type and mutant strains of Metarhizium anisopliae var. anisopliae.” Revista de Microbiologia 27.4 (1996): 237-41; Valadares-Inglis, M. C. and J. L. Azevedo. “Amylase and protease secretion in recombinant strains of Metarhizium anisopliae var. anisopliae following parasexual crosses.” Brazilian Journal of Genetics 20.2 (1997): 171-75; Valadares-Inglis, M. C. and J. F. Peberdy. “Location of chitinolytic enzymes in protoplasts and whole cells of the entomopathogenic fungus Metarhizium anisopliae.” Mycological Research 101.11 (1997): 1393-96; Wang, C. S., M. A. Typas, and T. M. Butt. “Detection and characterisation of pr1 virulent gene deficiencies in the insect pathogenic fungus Metarhizium anisopliae.” FEMS Microbiology Letters 213.2 (2002): 251-55; Wei, Z., Y. Q. Cao, and Y. X. Xia. “Cloning of the subtilisin Pr1A gene from a strain of locust specific fungus, Metarhizium anisopliae, and functional expression of the protein in Pichia pastoris.” World Journal of Microbiology and Biotechnology 24.11 (2008): 2481-88; U.S. Pat. No. 5,962,765; WO/2008/063011.

Microorganisms:

In one embodiment, the compositions described herein may optionally comprise one or more microorganisms, other than the fungal pesticides describe herein. The one or more microorganisms can have a variety of beneficial properties when applied to the compositions described herein. In one embodiment, the one or more microorganisms may be used to reduce odors associated with dead or decaying pests. In another embodiment, the one or more microorganisms may be used to produce enzymes to enhance the activity of the fungal pesticides herein (e.g., the cuticle degrading enzymes described herein). In still another embodiment, the one or more microorganisms may further produce or express toxins which supplement and/or enhance the activity of the fungal pesticide (e.g. δ-endotoxin, α-exotoxin, β-exotoxin, and combinations thereof produced by Bacillus thuringiensis). In yet another embodiment, the one or more microorganisms may further produce or express CO₂ to attract target pests.

In at least one embodiment, the one or more microorganisms are one or more bacterium (i.e., bacteria). In still another embodiment, the composition comprises bacteria capable of producing the enzymes described herein. Non-limiting examples of bacteria capable of producing enzymes are described in Gupta, R., Beg, Q. K., and Lorenz, P. “Bacterial alkaline proteases: molecular approaches and industrial applications.” (2002) 59: 15-32.

Non-limiting examples of bacterial pesticides that may be used in the compositions disclosed herein include species of Bacillus, Pseudomonas, Clostridium, Enterobacteriaceae, Vibrionaceae, Streptococcaceae, Actinomycetes, Rickettsiae, and Mollicutes. Non-limiting examples of species of bacterial pesticides include Bacillus licheniformis, Bacillus lentus, Bacillus subtilis, Bacillus alcalophilus, Bacillus amyloliquefaciens, Bacillus pumilus, Bacillus alvei, Bacillus aminovorans, Bacillus aneurinolyticus, Bacillus aquaemaris, Bacillus atrophaeus, Bacillus boroniphilius, Bacillus brevis, Bacillus caldolyticus, Bacillus centrosporus, Bacillus cereus, Bacillus circulans, Bacillus coagulans, Bacillus firmus, Bacillus flavothermus, Bacillus fusiformis, Bacillus globigii, Bacillus infernus, Bacillus larvae, Bacillus laterosporus, Bacillus lentus, Bacillus lentimorbus, Bacillus megaterium, Bacillus, mesentericus, Bacillus mucilaginosus, Bacillus moritai, Bacillus mycoides, Bacillus natto, Bacillus pantotherticus, Bacillus polymyxa, Bacillus popilliae, Bacillus schlegelii, Bacillus sphaericus, Bacillus sporoterhmodurans, Bacillus stearothermophillus, Bacillus thermoglucosidasius, Bacillus thuringiensis, Bacillus vulgatis, Bacillus weihenstephanensis, Pseudomonas aeruginosa, Pseudomonas septica, Pseudomonas chlororaphis, Pseudomonas fluorescens, Pseudomonas putida, Pseudomonas auerofaciens, Clostridium brevifaciens, Clostridium malcosomae, Enterobacter cloacae, Enterobacter aerogenes, Serratia marcescens, Serratia liquefaciens, Serratia entomophila, Costelytra zealandica, Serratia, piscatorum, Proteus vulgaris, Proteus, mirabilis, Proteus rettgeri, Xenorhabdus nematophilus, Xenorhabdus luminescens, Aeromonas punctata, Streptococcus pluton, Streptococcus faecalis, Cornyebacterium okanaganae, Rickettsiella popilliae, Rickettsiella tipulae, Rickettsiella grylli, Rickettsiella chironomi, Rickettsiella blattae, Rickettsiella tenebrionis, Rickettsiella schistocercae, Rickettsiella cetonidarum, Rickettsiella armadillidii, Rickettsiella melolonthae, Rickettsiella stethorae, Spiroplasma apis, Spiroplasma citri, and combinations thereof.

Non-limiting examples of microbes capable of producing CO₂ and that may be used in the compositions disclosed herein include species of yeast. Non-limiting examples of CO₂ producing yeast include Saccharomyces. In a particular embodiment, the CO₂ producing yeast is Saccharomyces cereviciae. See, Pedrini, N., et al. “Control of Pyrethoid-Resistant Chagas Disease Vectors with Entomopathogenic Fungi.” PLoS Negl Trop Dis 3(5): e434. Doi:10.1371/journal.pntd.0000434.

The compositions disclosed herein may include any of the microorganisms provided above, including any combination thereof. The microorganisms disclosed should be stable and retain a sufficient effective amount of activity when used. Methods for producing stabilized microorganisms are known in the art. In one embodiment, the microorganism is a microorganism present in the composition in the form of a stable spore. In another embodiment, the microorganism is a bacteria present in the composition in the form of a stable spore.

Metabolites:

In one embodiment, the compositions described herein may optionally comprise one or more metabolites. The one or more metabolites can have a variety of beneficial properties when applied to the compositions described herein. In one embodiment, the one or more metabolites may be used to enhance the activity of the fungal pesticides herein. Non-limiting examples of fungal pesticides that may be used in the compositions disclosed herein are described in Anke, H. “Insecticidal and Nematicidal Metabolites from Fungi. Industrial Applications, 2nd ed. The Mycota X” (M. Hofrichter, ed.), (2010): Springer-Verlag Berlin Heidelberg, 151-163. In one embodiment, non-limiting examples of metabolites include alkaloids, peptides, cyclic peptides, cyclic depsipeptides, quinolone derivatives, nodulisporic acids, paraherquamide metabolites, nafuredin, and combinations thereof.

Chemical Pesticides and Biopesticides (e.g. Insecticides, Bioinsecticides, etc.)

In an embodiment, one or more chemical pesticides, biopesticides, or combinations thereof may be applied either simultaneously or applied sequentially, with the fungal pesticides disclosed herein. In at least one embodiment, the compositions described herein may optionally comprise a fungal pesticide in combination with a chemical pesticides and/or biopesticide (e.g., insecticides, including other bioinsecticides, etc.). In another embodiment, the compositions described herein contain at least one active ingredient from one or more chemical classifications known in the art to control pests. Non-limiting examples of chemical classifications and active ingredients include pyrethroids (e.g., permetherin, resmethrin, phenothrin, deltamethrin, bioallethrin, D-allethrin, esfenvalerate, tetramethrin, cyphenothrin, imiprothrin, alkyl dimethyl benzyl ammonium chloride, beta-cyfluthrin, prallethrin, bifenthrin, lambda-cyhalothrin, zeta-cypermethrin, gamma-cyhalothrin), organophosphates (e.g., dichlorvos, etc.), pyrethrins (e.g., pyrethrin, etc.) neonicotinoids (e.g., imidacloprid, acetamiprid, dinotefuran, etc.) carbamates (e.g., propoxur, etc.), pyroles (e.g., chlorfenapyr, etc.) and combinations thereof.

Non-limiting examples of additional insecticides and biopesticides include: antibiotic insecticides such as allosamidin and thuringiensin; macrocyclic lactone insecticides such as spinosad, spinetoram, and other spinosyns including the 21-butenyl spinosyns and their derivatives; avermectin insecticides such as abamectin, doramectin, emamectin, eprinomectin, ivermectin and selamectin; milbemycin insecticides such as lepimectin, milbemectin, milbemycin oxime and moxidectin; arsenical insecticides such as calcium arsenate, copper acetoarsenite, copper arsenate, lead arsenate, potassium arsenite and sodium arsenite; other biological insecticides, plant incorporated protectant insecticides such as Cry1Ab, Cry1Ac, Cry1F, Cry1A.105, Cry2Ab2, Cry3A, mir Cry3A, Cry3Bb1, Cry34, Cry35, and VIP3A; botanical insecticides such as anabasine, azadirachtin, d-limonene, nicotine, pyrethrins, cinerins, cinerin I, cinerin II, jasmolin I, jasmolin II, pyrethrin I, pyrethrin II, quassia, rotenone, ryania and sabadilla; carbamate insecticides such as bendiocarb and carbaryl; benzofuranyl methylcarbamate insecticides such as benfuracarb, carbofuran, carbosulfan, decarbofuran and furathiocarb; dimethylcarbamate insecticides dimitan, dimetilan, hyquincarb and pirimicarb; oxime carbamate insecticides such as alanycarb, aldicarb, aldoxycarb, butocarboxim, butoxycarboxim, methomyl, nitrilacarb, oxamyl, tazimcarb, thiocarboxime, thiodicarb and thiofanox; phenyl methylcarbamate insecticides such as allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC and xylylcarb; dinitrophenol insecticides such as dinex, dinoprop, dinosam and DNOC; fluorine insecticides such as barium hexafluorosilicate, cryolite, sodium fluoride, sodium hexafluorosilicate and sulfluramid; formamidine insecticides such as amitraz, chlordimeform, formetanate and formparanate; fumigant insecticides such as acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, iodomethane, methyl bromide, methylchloroform, methylene chloride, naphthalene, phosphine, sulfuryl fluoride and tetrachloroethane; inorganic insecticides such as borax, calcium polysulfide, copper oleate, mercurous chloride, potassium thiocyanate and sodium thiocyanate; chitin synthesis inhibitors such as bistrifluoron, buprofezin, chlorfluazuron, cyromazine, diflubenzuron, flucycloxuron, flufenoxuron, hexaflumuron, lufenuron, novaluron, noviflumuron, penfluoron, teflubenzuron and triflumuron; juvenile hormone mimics such as epofenonane, fenoxycarb, hydroprene, kinoprene, methoprene, pyriproxyfen and triprene; juvenile hormones such as juvenile hormone I, juvenile hormone II and juvenile hormone III; moulting hormone agonists such as chromafenozide, halofenozide, methoxyfenozide and tebufenozide; moulting hormones such as .alpha.-ecdysone and ecdysterone; moulting inhibitors such as diofenolan; precocenes such as precocene I, precocene II and precocene III; unclassified insect growth regulators such as dicyclanil; nereistoxin analogue insecticides such as bensultap, cartap, thiocyclam and thiosultap; nicotinoid insecticides such as flonicamid; nitroguanidine insecticides such as clothianidin, dinotefuran, imidacloprid and thiamethoxam; nitromethylene insecticides such as nitenpyram and nithiazine; pyridylmethylamine insecticides such as acetamiprid, imidacloprid, nitenpyram and thiacloprid; organochlorine insecticides such as bromo-DDT, camphechlor, DDT, pp′-DDT, ethyl-DDD, HCH, gamma-HCH, lindane, methoxychlor, pentachlorophenol and TDE; cyclodiene insecticides such as aldrin, bromocyclen, chlorbicyclen, chlordane, chlordecone, dieldrin, dilor, endosulfan, endrin, HEOD, heptachlor, HHDN, isobenzan, isodrin, kelevan and mirex; organophosphate insecticides such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, TEPP and tetrachlorvinphos; organothiophosphate insecticides such as dioxabenzofos, fosmethilan and phenthoate; aliphatic organothiophosphate insecticides such as acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, IPSP, isothioate, malathion, methacrifos, oxydemeton-methyl, oxydeprofos, oxydisulfoton, phorate, sulfotep, terbufos and thiometon; aliphatic amide organothiophosphate insecticides such as amidithion, cyanthoate, dimethoate, ethoate-methyl, formothion, mecarbam, omethoate, prothoate, sophamide and vamidothion; oxime organothiophosphate insecticides such as chlorphoxim, phoxim and phoxim-methyl; heterocyclic organothiophosphate insecticides such as azamethiphos, coumaphos, coumithoate, dioxathion, endothion, menazon, morphothion, phosalone, pyraclofos, pyridaphenthion and quinothion; benzothiopyran organothiophosphate insecticides such as dithicrofos and thicrofos; benzotriazine organothiophosphate insecticides such as azinphos-ethyl and azinphos-methyl; isoindole organothiophosphate insecticides such as dialifos and phosmet; isoxazole organothiophosphate insecticides such as isoxathion and zolaprofos; pyrazolopyrimidine organothiophosphate insecticides such as chlorprazophos and pyrazophos; pyridine organothiophosphate insecticides such as chlorpyrifos and chlorpyrifos-methyl; pyrimidine organothiophosphate insecticides such as butathiofos, diazinon, etrimfos, lirimfos, pirimiphos-ethyl, pirimiphos-methyl, primidophos, pyrimitate and tebupirimfos; quinoxaline organothiophosphate insecticides such as quinalphos and quinalphos-methyl; thiadiazole organothiophosphate insecticides such as athidathion, lythidathion, methidathion and prothidathion; triazole organothiophosphate insecticides such as isazofos and triazophos; phenyl organothiophosphate insecticides such as azothoate, bromophos, bromophos-ethyl, carbophenothion, chlorthiophos, cyanophos, cythioate, dicapthon, dichlofenthion, etaphos, famphur, fenchlorphos, fenitrothion fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3 and trifenofos; phosphonate insecticides such as butonate and trichlorfon; phosphonothioate insecticides such as mecarphon; phenyl ethylphosphonothioate insecticides such as fonofos and trichloronat; phenyl phenylphosphonothioate insecticides such as cyanofenphos, EPN and leptophos; phosphoramidate insecticides such as crufomate, fenamiphos, fosthietan, imicyafos, mephosfolan, phosfolan and pirimetaphos; phosphoramidothioate insecticides such as acephate, isocarbophos, isofenphos, methamidophos and propetamphos; phosphorodiamide insecticides such as dimefox, mazidox, mipafox and schradan; oxadiazine insecticides such as indoxacarb; phthalimide insecticides such as dialifos, phosmet and tetramethrin; pyrazole insecticides such as acetoprole, ethiprole, fipronil, pyrafluprole, pyriprole, tebufenpyrad, tolfenpyrad and vaniliprole; pyrethroid ester insecticides such as acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, biopermethrin, cismethrin, tefluthrin, terallethrin, tetramethrin, tralomethrin and transfluthrin; pyrethroid ether insecticides such as etofenprox, flufenprox, halfenprox, protrifenbute and silafluofen; pyrimidinamine insecticides such as flufenerim and pyrimidifen; pyrrole insecticides such as chlorfenapyr; tetronic acid insecticides such as spirodiclofen, spiromesifen and spirotetramat; thiourea insecticides such as diafenthiuron; urea insecticides such as flucofuron and sulcofuron; and unclassified insecticides such as AKD-3088, chlorantraniliprole, closantel, crotamiton, cyflumetofen, E2Y45, EXD, fenazaflor, fenazaquin, fenoxacrim, fenpyroximate, FKI-1033, flubendiamide, HGW86, hydramethylnon, IKI-2002, isoprothiolane, malonoben, metaflumizone, metoxadiazone, nifluridide, NNI-9850, NNI-0101, pymetrozine, pyridaben, pyridalyl, pyrifluquinazon, Qcide, rafoxanide, Rynaxypyr™, SYJ-159, triarathene and triazamate and any combinations thereof.

### Synergists

In at least one embodiment, the compositions described herein may optionally comprise one or more synergists. Non-limiting examples of synergists include N-Octyl bicycloheptene dicarboximide (MGK 264), piperonyl butoxide, and combinations thereof.

### Desiccants

In at least one embodiment, the compositions described herein may optionally comprise one or more desiccants. Non-limiting examples of desiccants include diatomaceous earth, boric acid, silicon dioxide, and combinations thereof.

### Insect Growth Regulators

In at least one embodiment, the compositions described herein may optionally comprise one or more insect growth regulators which have a negative effect on insect growth. Non-limiting examples of insect growth regulators include pyripoxyfen, ethofenprox, cold-pressed neem oil, S-hydroprene, chitin synthesis inhibitors, juvenile hormone analogs (e.g. methoprene) and combinations thereof.

### Electrostatic Carriers

In at least one embodiment, the compositions described herein may optionally comprise one or more electrostatic carriers which will enhance the horizontal transmission of the fungal pesticide. Non-limiting examples of electrostatic carriers include charged and/or electrostatic waxes and powders such as carnauba wax and the highly-electrostatic ENTOSTAT® powder (manufactured by Exosect, Shouthampton, UK).

### Attractants

In at least one embodiment, the compositions described herein may optionally comprise one or more attractants. Non-limiting examples of attractants which may be included in the compositions described herein include, food, food aromas, lactic acid, propionic acid, butyric acid, valeric acid, octenol, pheromones, “glow-in-the dark” materials (e.g., phosphors such as zinc sulfide, strontium aluminate, etc., radioactive isotopes such as tritium, etc.) and combinations thereof.

In additional embodiments, attractants may not be an ingredient of the compositions but rather a stimulus/stimuli that is an external stimulus/stimuli. Non-limiting examples of these attractants include thermostimuli (e.g., heat or a source of heat), mechanostimuli (e.g., airborne sound waves, or substrate borne pressure waves), electromagnetic stimuli (e.g., visual stimuli such as patterns, objects, color, and/or light (e.g., fluorescent lights, and “glow in the dark” materials), and chemical stimuli (including, but not limited to carbon dioxide (CO₂) and sources providing CO₂).

In an embodiment, the attractant is CO₂ or a source providing CO₂. CO₂ is easily produced by those skilled in the art. Non-limiting examples of CO₂ production include microbial production of CO₂ (see, Pedrini, N., et al. “Control of Pyrethoid-Resistant Chagas Disease Vectors with Entomopathogenic Fungi.” PLoS Negl Trop Dis 3(5): e434. doi:10.1371/journal.pntd.0000434), combustion, release of CO₂ from bottles, dry ice, chemical reactions, and/or catalytic processes. (CO₂ generators and methods for producing CO₂ are described in U.S. Pat. No. 8,133,524. Non-limiting commercially available CO₂ generators are provided by Green Air Products, Inc., the NightWatch® Bed Bug Trap (manufactured by Biosensory, Putnam, Conn., USA) the CDC 3000 (manufactured by Cimex Science, LLC, West Linn, Oreg., USA) the Verifi® Bed Bug Detector (manufactured by FMC Professional Solutions, Philadelphia, Pa., USA), etc. In another embodiment, the attractant(s) may be made operative or inoperative (e.g., turned on and off) by a user or through other mechanical methods known to those skilled in the art (e.g., the attractant(s) may be turned on and off at a specific time(s) if the attractants are interfaced with a timer or other device capable of making the attractant(s) operable and inoperable).

### Rheology Modifying Agents

In at least one embodiment, the fungal pesticide compositions described herein may optionally comprise one or more rheology modifying agents. The one or more rheology modifying agents may comprise thickeners. In one embodiment, the compositions described herein may optionally comprise one or more thickeners. Non-limiting examples of thickeners include organic polymers such as partially or fully neutralized polyacrylic acids, polyvinylpyrrolidone homo- or copolymers, polyethylene glycols, ethylene oxide/propylene oxide copolymers, polyvinyl alcohols and non-ionically or ionically modified celluloses, thixotropic xanthan-based thickeners, and moreover inorganic disperse thickeners such as precipitated or pyrogenic silicas, kaolins, bentonites, aluminum/silicon mixed oxides, and silicates.

### Preservatives

In at least one embodiment, the fungal pesticide compositions described herein may optionally comprise one or more preservatives. Non-limiting examples of preservatives include biocides (e.g., Nipacide™), bacteriostats, (e.g., sodium azide, thimerosol, etc.), bactericides (e.g. 2-bromo-2-nitro-1,3-propanadiol, 1-(3-chloroallyl)-3,5,7-triaza-1-azoniaadamantane chloride, dibromonitrilopropionamide, 1,2-benzisothiazolin-3-one, 5-chloro-2-methyl-4-isosthiazolin-3-one, 2-methyl-4-isosthiazolin-3-one, diazolidinyl urea, tris(hydroxymethyl)nitromethane, sodium o-phenylphenate, copper arsenates, cuprous oxide, compounds of arsenic, copper, mercury, quarternary ammonium compounds, etc.), Bronopol (i.e., BIOBAN™ BP-PLUS), Kathon CG/ICP,and chelating agents (e.g., EDTA, etc.) and combinations thereof.

### Colorants

In at least one embodiment, the fungal pesticide compositions described herein may optionally comprise one or more colorants.

Non-limiting examples of colorants include soluble and/or sparingly soluble color pigments, (e.g., titanium dioxide, color black or zinc oxide, etc.), and combinations thereof.

### Opacifiers

In at least one embodiment, the fungal pesticide compositions described herein may optionally comprise one or more opacifiers. Non-limiting examples of opacifiers include tin dioxide, carbon black, etc., and combinations thereof.

### Antioxidants

In at least one embodiment, the fungal pesticide compositions described herein may optionally comprise one or more antioxidants. Non-limiting examples of antioxidants include vitamins (e.g., Vitamin E, α-tocopherol, etc.), sterically hindered phenols, alkyl-substituted hydroxyanisoles, hydroxytoluenes and combinations thereof.

### Fillers

In at least one embodiment, the fungal pesticide compositions described herein may optionally comprise one or more fillers. Non-limiting examples of fillers include ground minerals, calcium carbonate, ground quartz, aluminum/silicon mixed oxides or mixed hydroxides, and combinations thereof.

### Methods

Disclosed herein are methods for controlling one or more target pests. Methods of controlling the one or more target pests are known in to those of skill in the art and include, but are not limited, to spraying, fumigating, or otherwise applying the compositions described herein to the one or more target pests or surfaces which may come into contact with the one or more target pests.

In a particular embodiment, the target pest is a plant pest. As described herein, plant pest may include, but should not be limited to:

Hemiptera Harmful Insects:

Planthoppers (Delphacidae) such as small brown planthopper (Laodelphax striatellus), brown rice planthopper (Nilaparvata lugens), white-backed rice planthopper (Sogatella furcifera) and the like; leafhoppers (Deltocephalidae) such as green rice leafhopper (Nephotettix cincticeps), green rice leafhopper (Nephotettix virescens) and the like; aphids (Aphididae) such as cotton aphid (Aphis gossypii), green peach aphid (Myzus persicae), cabbage aphid (Brevicoryne brassicae), potato aphid (Macrosiphum euphorbiae), foxglove aphid (Aulacorthum solani), oat bird-cherry aphid (Rhopalosiphum padi), tropical citrus aphid (Toxoptera citricidus) and the like; stink bugs (Pentatomidae) such as green stink bug (Nezara antennata), bean bug (Riptortus clavetus), rice bug (Leptocorisa chinensis), white spotted spined bug (Eysarcoris parvus), stink bug (Halyomorpha mista), tarnished plant bug (Lyus lineolarxs) and the like; whiteflies (Aleyrodidae) such as greenhouse whitefly (Trialeurodes vaporariorum), sweetpotato whitefly (Bemisia tabaci), silverleaf whitefly (Bemisia argentifolii) and the like; scales (Coccidae) such as Calfornia red scale (Aonidiella aurantii), San Jose scale (Comstockaspis perniciosa), citrus north scale (Unaspis citri), red wax scale (Ceroplastes rubens), cottonycushion scale (Icerya purchasi) and the like; lace bugs (Tingidae); psyllids (Psyllidae); etc.

Lepidoptera Harmful Insects:

Pyralid moths (Pyralidae) such as rice stem borer (Chilo suppressalis), yellow rice borer (Tryporyza incertulas), rice leafroller (Cnaphalocrocis medinalis), cotton leafroller (Notarcha derogata), Indian meal moth (Plodia interpunctella), oriental corn borer (Ostrinia fumacalis), European corn borer (Ostrinianubilaris), cabbage webworm (Hellula undalis), bluegrass webworm (Pediasia teterrellus) and the like; owlet moths (Noctuidae) such as common cutworm (Spodoptera litura), beet armyworm (Spodoptera exigua), armyworm (Pseudaletia separata), cabbage armyworm (Mamestra brassicae), black cutworm (Agrotis ipsilon), beet semi-looper (Plusia nigrisigna), Thoricoplusia spp., Heliothis spp., Helicoverpa spp. and the like; white butterflies (Pieridae) such as common white (Pieris rapae) and the like; tortricid moths (Tortricidae) such as Adoxophyes spp., oriental fruit moth (Grapholita molesta), soybean pod borer (Leguminivora glycinivorella), azuki bean podworm (Matsumuraeses azukivora), summer fruit tortrix (Adoxophyes orana fasciata), smaller tea tortrix (Adoxophyes spp.), oriental tea tortrix (Homona magnanima), apple tortrix (Archips fuscocupreanus), codling moth (Cydia pomonella) and the like; leafblotch miners (Gracillariidae) such as tea leafroller (Caloptilia theivora), apple leafminer (Phyllonorycter ringoneella) and the like; Carposinidae such as peach fruit moth (Carposina niponensis) and the like; lyonetiid moths (Lyonetiidae) such as Lyonetia spp. and the like; tussock moths (Lymantriidae) such as Lymantria spp., Euproctis spp. and the like; yponomeutid moths (Yponomeutidae) such as diamondback (Plutella xylostella) and the like; gelechiid moths (Gelechiidae) such as pink bollworm (Pectinophora gossypiella), potato tubeworm (Phthorimaea operculella) and the like; tiger moths and allies (Arctiidae) such as fall webworm (Hyphantria cunea) and the like; tineid moths (Tineidae) such as casemaking clothes moth (Tinea translucens), webbing clothes moth (Tineola bisselliella) and the like; etc.

Thysanoptera Harmful Insects:

Thrips (Thripidae) such as western flower thrips (Frankliniella occidentalis), melon thrips (Thrips palmi), yellow tea thrips (Scirtothrips dorsalis), onion thrips (Thrips tabaci), flower thrips (Frankliniella intonsa), tobacco thrips (Frankliniella fusca) and the like, etc.;

Diptera Harmful Insects:

House flies (Musca domestica), common house mosquito (Culex popiens pallens), horsefly (Tabanus trigonus), onion fly (Hylemya antiqua), seedcorn maggot (Hylemya platura), asian tiger mosquito (Anopheles sinensis); leafminer flies (Agromyzidae) such as rice leafminer (Agromyza oryzae), little rice leafminer (Hydrellia griseola), rice stemmaggot (Chlorops oryzae), legume leafminer (Liriomyza trifolii) and the like; melon fly (Dacus cucurbitae), Mediterranean fruit fly (Ceratitis capitata), etc.;

Coleoptera Harmful Insects:

Twenty-eight-spotted ladybird (Epilachna vigintioctopunctata), cucurbit leaf beetle (Aulacophora femoralis), striped flea beetle (Phyllotreta striolata), rice leaf beetle (Oulema oryzae), rice curculio (Echinocnemus squameus), rice water weevil (Lissorhoptrus oryzophilus), boll weevil (Anthonomus grandis), azuki bean weevil (Callosobruchus chinensis), hunting billbug (Sphenophorus venatus), Japanese beetle (Popxllia japonica), cupreous chafer (Anomala cuprea), Corn root worms (Diabrotica spp.), Colorado potato beetle (Leptinotarsa decemlineata), click beetles (Agriotes spp.), cigarette beetle (Lasioderma serricorne), varied carper beetle (Anthrenus verbasci), red flour beetle (Tribolium castaneum), powder-post beetle (Lyctus brunneus), white-spotted longicorn beetle (Anoplophora malasiaca), pine shoot beetle (Tomicus piniperda), etc.;

Orthoptera Harmful Insects:

Asiatic locust (Locusta migratoria), African mole cricket (Gryllotalpa africana), rice grasshopper (Oxya yezoensis), rice grasshopper (Oxya japonica), etc.;

Hymenoptera Harmful Insects:

Cabbage sawfly (Athalia rosae), leaf-cutting ant (Acromyrmex spp.), fire ant (Solenopsis spp.), etc.;

Blattodea Harmful Insects:

German cockroach (Blattella germanica), smokybrown cockroach (Periplaneta fuliginosa), American cockroach (Periplaneta americana), Periplaneta brunnea, oriental cockroach (Blatta orientalis), etc.

Particular examples of the above-described harmful arthropods include aphids (Aphididae), Thrips (Thripidae), leafminer flies (Agromyzidae), horsehair worms (Paragordius tricuspidatus), Colorado potato beetle (Leptinotarsa decemlineata), Japanese beetle (Popiffia japonica), cupreous chafer (Anomala cuprea), boll weevil (Anthonomus grandis), rice water weevil (Lissorhoptrus oryzophilus), tobacco thrips (Frankliniella fusca), Corn root worms (Diabrotica spp.), diamondback (Plutella xylostella), cabbageworms, soybean pod borer (Leguminivora glycinivorella), and the like.

In one aspect, the method comprises contacting one or more plant pests with (e.g., an effective amount of) a first fungal pesticide and a second fungal pesticide. According to the method, the first fungal pesticide and the second fungal pesticide may be different strains of the same species or strains of different species. In a particular embodiment, the first fungal pesticide and the second pesticide are applied sequentially. In another embodiment, the first fungal pesticide and the second fungal pesticide are ingredients in separate compositions as described herein which are applied sequentially. In yet another embodiment, the first fungal pesticide and the second fungal pesticide are applied simultaneously. In a particular embodiment, the first fungal pesticide and the second pesticide are ingredients in a single composition as described herein.

According to the method, the first fungal pesticide may be a fungal pesticide selected from the group consisting of Coelomycidium, Myiophagus, Coelemomyces, Lagenidium, Leptolegnia, Couchia, Sporodiniella, Conidiobolus, Entomophaga, Entomophthora, Erynia, Massospora, Meristacrum, Neozygites, Pandora, Zoophthora, Blastodendrion, Metschnikowia, Mycoderma, Ascophaera, Cordyceps, Torrubiella, Nectria, Hypocrella, Calonectria, Filariomyces, Hesperomyces, Trenomyces, Myriangium, Podonectria, Akanthomyces, Aschersonia, Aspergillus, Beauveria, Culicinomyces, Engyodontium, Fusarium, Gibellula, Hirsutella, Hymenostilbe, Isaria, Metarhizium, Nomuraea, Paecilomyces, Paraisaria, Pleurodesmospora, Polycephalomyces, Pseudogibellula, Sorosporella, Stillbella, Tetranacrium, Tilachlidium, Tolypocladium, Verticillium, Aegerita, Filobasidiella, Septobasidium, and Uredinella. The second fungal pesticide may be a fungal pesticide selected from the group consisting of Coelomycidium, Myiophagus, Coelemomyces, Lagenidium, Leptolegnia, Couchia, Sporodiniella, Conidiobolus, Entomophaga, Entomophthora, Erynia, Massospora, Meristacrum, Neozygites, Pandora, Zoophthora, Blastodendrion, Metschnikowia, Mycoderma, Ascophaera, Cordyceps, Torrubiella, Nectria, Hypocrella, Calonectria, Filariomyces, Hesperomyces, Trenomyces, Myriangium, Podonectria, Akanthomyces, Aschersonia, Aspergillus, Beauveria, Culicinomyces, Engyodontium, Fusarium, Gibellula, Hirsutella, Hymenostilbe, Isaria, Metarhizium, Nomuraea, Paecilomyces, Paraisaria, Pleurodesmospora, Polycephalomyces, Pseudogibellula, Sorosporella, Stillbella, Tetranacrium, Tilachlidium, Tolypocladium, Verticillium, Aegerita, Filobasidiella, Septobasidium, and Uredinella.

In one embodiment, the first fungal pesticide and the second fungal pesticide are different strains of Metarhizium sp. In another embodiment, the first fungal pesticide and the second fungal pesticide are different strains of Metarhizium anisopliae. In still a further embodiment, one of the first fungal pesticide or the second fungal pesticide is the strain Metarhizium anisopliae F52. In still another embodiment the first fungal pesticide and the second fungal pesticide are different strains of Beauveria sp. In yet another embodiment, the first fungal pesticide and the second fungal pesticide are different strains of Beauveria bassiana. In still a further embodiment, one of the first fungal pesticide or the second fungal pesticide is the strain Beauveria bassiana ATCC-74040. In another embodiment, one of the first fungal pesticide or the second fungal pesticide is the strain Beauveria bassiana ATCC-74250. In another embodiment, the first fungal pesticide is the strain Beauveria bassiana ATCC-74040 and the second fungal pesticide is the strain Beauveria bassiana ATCC-74250.

In another embodiment the first fungal pesticide is a strain of Metarhizium sp. and the second fungal pesticide is a strain of Beauveria sp. In still another embodiment, the first fungal pesticide is a strain of Metarhizium sp. and the second fungal pesticide is a strain of Beauveria bassiana. In yet another embodiment, the first fungal pesticide is a strain of Metarhizium sp. and the second fungal pesticide is the strain Beauveria bassiana ATCC-74040. In still yet another embodiment, the first fungal pesticide is a strain of Metarhizium sp. and the second fungal pesticide is the strain Beauveria bassiana ATCC-74250.

In another embodiment the first fungal pesticide is a strain of Metarhizium anisopliae and the second fungal pesticide is a strain of Beauveria sp. In still another embodiment, the first fungal pesticide is a strain of Metarhizium anisopliae and the second fungal pesticide is a strain of Beauveria bassiana. In yet another embodiment, the first fungal pesticide is a strain of Metarhizium anisopliae and the second fungal pesticide is the strain Beauveria bassiana ATCC-74040. In still yet another embodiment, the first fungal pesticide is a strain of Metarhizium anisopliae and the second fungal pesticide is the strain Beauveria bassiana ATCC-74250.

In another embodiment the first fungal pesticide is the strain Metarhizium anisopliae F52 and the second fungal pesticide is a strain of Beauveria sp. In still another embodiment, the first fungal pesticide is the strain Metarhizium anisopliae F52 and the second fungal pesticide is a strain of Beauveria bassiana. In yet another embodiment, the first fungal pesticide is the strain Metarhizium anisopliae F52 and the second fungal pesticide is the strain Beauveria bassiana ATCC-74040. In still yet another embodiment, the first fungal pesticide is the strain Metarhizium anisopliae F52 and the second fungal pesticide is the strain Beauveria bassiana ATCC-74250.

In an embodiment, the first fungal pesticide controls plant pests at the egg stage, the nymph stage, the instar stage, the adult stage, or combinations thereof. In another embodiment, the first fungal pesticide controls plant pests at the egg stage, the nymph stage, the instar stage, the adult stage, or combinations thereof and is a strain of Metarhizium sp. In still another embodiment, the first fungal pesticide controls plant pests at the egg stage, the nymph stage, the instar stage, the adult stage, or combinations thereof and is a strain of Metarhizium anisopliae. In yet another embodiment, the first fungal pesticide controls plant pests at the egg stage, the nymph stage, the instar stage, the adult stage, or combinations thereof and is the strain Metarhizium anisopliae F52.

In a further embodiment, the second fungal pesticide controls plant pests at the egg stage, the nymph stage, the instar stage, the adult stage, or combinations thereof. In another embodiment, the second fungal pesticide controls plant pests at the egg stage, the nymph stage, the instar stage, the adult stage, or combinations thereof and is a strain of Beauveria sp. In still another embodiment, the second fungal pesticide controls plant pests at the egg stage, the nymph stage, the instar stage, the adult stage, or combinations thereof and is a strain of Beauveria bassiana. In yet another embodiment, the second fungal pesticide controls plant pests at the egg stage, the nymph stage, the instar stage, the adult stage, or combinations thereof and is the strain Beauveria bassiana ATCC-74040. In still yet another embodiment, the second fungal pesticide controls plant pests at the egg stage, the nymph stage, the instar stage, the adult stage, or combinations thereof and is the strain Beauveria bassiana ATCC-74250.

In a further embodiment the first fungal pesticide controls plant pests at the egg stage and the second fungal pesticide controls plant pests at the adult stage. In another embodiment, the first fungal pesticide controls plant pests at the egg stage and is a strain of Metarhizium sp. and the second fungal pesticide controls plant pests at the adult stage and is a strain of Beauveria sp. In yet another embodiment, the first fungal pesticide controls plant pests at the egg stage and is a strain of Metarhizium sp. and the second fungal pesticide controls plant pests at the adult stage and is a strain of Beauveria bassiana. In still another embodiment, the first fungal pesticide controls plant pests at the egg stage and is a strain of Metarhizium sp. and the second fungal pesticide controls plant pests at the adult stage and is the strain Beauveria bassiana ATCC74040. In still yet another embodiment, the first fungal pesticide controls plant pests at the egg stage and is a strain of Metarhizium sp. and the second fungal pesticide controls plant pests at the adult stage and is the strain Beauveria bassiana ATCC74250.

In yet another embodiment, the first fungal pesticide controls plant pests at the egg stage and is a strain of Metarhizium anisopliae and the second fungal pesticide controls plant pests at the adult stage and is a strain of Beauveria sp. In yet another embodiment, the first fungal pesticide controls plant pests at the egg stage and is a strain of Metarhizium anisopliae and the second fungal pesticide controls plant pests at the adult stage and is a strain of Beauveria bassiana. In still another embodiment, the first fungal pesticide controls plant pests at the egg stage and is a strain of Metarhizium anisopliae and the second fungal pesticide controls plant pests at the adult stage and is the strain Beauveria bassiana ATCC74040. In still yet another embodiment, the first fungal pesticide controls plant pests at the egg stage and is a strain of Metarhizium anisopliae and the second fungal pesticide controls plant pests at the adult stage and is the strain Beauveria bassiana ATCC74250.

In still yet another embodiment, the first fungal pesticide controls plant pests at the egg stage and is the strain Metarhizium anisopliae F52 and the second fungal pesticide controls plant pests at the adult stage and is a strain of Beauveria sp. In yet another embodiment, the first fungal pesticide controls plant pests at the egg stage and is the strain Metarhizium anisopliae F52 and the second fungal pesticide controls plant pests at the adult stage and is a strain of Beauveria bassiana.

In a specific embodiment, the first fungal pesticide controls plant pests at the egg stage and is the strain Metarhizium anisopliae F52 and the second fungal pesticide controls plant pests at the adult stage and is the strain Beauveria bassiana ATCC74040. In another specific embodiment, the first fungal pesticide controls plant pests at the egg stage and is the strain Metarhizium anisopliae F52 and the second fungal pesticide controls plant pests at the adult stage and is the strain Beauveria bassiana ATCC74250.

In a more specific embodiment, methods for controlling one or more bed bugs are disclosed. In one aspect, the method comprises contacting one or more bed bugs with (e.g., an effective amount of) a first fungal pesticide and a second fungal pesticide. According to the method, the first fungal pesticide and the second fungal pesticide may be different strains of the same species or strains of different species. In a particular embodiment, the first fungal pesticide and the second pesticide are applied sequentially. In another embodiment, the first fungal pesticide and the second fungal pesticide are ingredients in separate compositions as described herein which are applied sequentially. In yet another embodiment, the first fungal pesticide and the second fungal pesticide are applied simultaneously. In a particular embodiment, the first fungal pesticide and the second pesticide are ingredients in a single composition as described herein.

According to the method, the first fungal pesticide may be a fungal pesticide selected from the group consisting of Coelomycidium, Myiophagus, Coelemomyces, Lagenidium, Leptolegnia, Couchia, Sporodiniella, Conidiobolus, Entomophaga, Entomophthora, Erynia, Massospora, Meristacrum, Neozygites, Pandora, Zoophthora, Blastodendrion, Metschnikowia, Mycoderma, Ascophaera, Cordyceps, Torrubiella, Nectria, Hypocrella, Calonectria, Filariomyces, Hesperomyces, Trenomyces, Myriangium, Podonectria, Akanthomyces, Aschersonia, Aspergillus, Beauveria, Culicinomyces, Engyodontium, Fusarium, Gibellula, Hirsutella, Hymenostilbe, Isaria, Metarhizium, Nomuraea, Paecilomyces, Paraisaria, Pleurodesmospora, Polycephalomyces, Pseudogibellula, Sorosporella, Stillbella, Tetranacrium, Tilachlidium, Tolypocladium, Verticillium, Aegerita, Filobasidiella, Septobasidium, and Uredinella. The second fungal pesticide may be a fungal pesticide selected from the group consisting of Coelomycidium, Myiophagus, Coelemomyces, Lagenidium, Leptolegnia, Couchia, Sporodiniella, Conidiobolus, Entomophaga, Entomophthora, Erynia, Massospora, Meristacrum, Neozygites, Pandora, Zoophthora, Blastodendrion, Metschnikowia, Mycoderma, Ascophaera, Cordyceps, Torrubiella, Nectria, Hypocrella, Calonectria, Filariomyces, Hesperomyces, Trenomyces, Myriangium, Podonectria, Akanthomyces, Aschersonia, Aspergillus, Beauveria, Culicinomyces, Engyodontium, Fusarium, Gibellula, Hirsutella, Hymenostilbe, Isaria, Metarhizium, Nomuraea, Paecilomyces, Paraisaria, Pleurodesmospora, Polycephalomyces, Pseudogibellula, Sorosporella, Stillbella, Tetranacrium, Tilachlidium, Tolypocladium, Verticillium, Aegerita, Filobasidiella, Septobasidium, and Uredinella.

In one embodiment, the first fungal pesticide and the second fungal pesticide are different strains of Metarhizium sp. In another embodiment, the first fungal pesticide and the second fungal pesticide are different strains of Metarhizium anisopliae. In still a further embodiment, one of the first fungal pesticide or the second fungal pesticide is the strain Metarhizium anisopliae F52. In still another embodiment the first fungal pesticide and the second fungal pesticide are different strains of Beauveria sp. In yet another embodiment, the first fungal pesticide and the second fungal pesticide are different strains of Beauveria bassiana. In still a further embodiment, one of the first fungal pesticide or the second fungal pesticide is the strain Beauveria bassiana ATCC-74040. In another embodiment, one of the first fungal pesticide or the second fungal pesticide is the strain Beauveria bassiana ATCC-74250. In another embodiment, the first fungal pesticide is the strain Beauveria bassiana ATCC-74040 and the second fungal pesticide is the strain Beauveria bassiana ATCC-74250.

In another embodiment the first fungal pesticide is a strain of Metarhizium sp. and the second fungal pesticide is a strain of Beauveria sp. In still another embodiment, the first fungal pesticide is a strain of Metarhizium sp. and the second fungal pesticide is a strain of Beauveria bassiana. In yet another embodiment, the first fungal pesticide is a strain of Metarhizium sp. and the second fungal pesticide is the strain Beauveria bassiana ATCC-74040. In still yet another embodiment, the first fungal pesticide is a strain of Metarhizium sp. and the second fungal pesticide is the strain Beauveria bassiana ATCC-74250.

In another embodiment the first fungal pesticide is a strain of Metarhizium anisopliae and the second fungal pesticide is a strain of Beauveria sp. In still another embodiment, the first fungal pesticide is a strain of Metarhizium anisopliae and the second fungal pesticide is a strain of Beauveria bassiana. In yet another embodiment, the first fungal pesticide is a strain of Metarhizium anisopliae and the second fungal pesticide is the strain Beauveria bassiana ATCC-74040. In still yet another embodiment, the first fungal pesticide is a strain of Metarhizium anisopliae and the second fungal pesticide is the strain Beauveria bassiana ATCC-74250.

In another embodiment the first fungal pesticide is the strain Metarhizium anisopliae F52 and the second fungal pesticide is a strain of Beauveria sp. In still another embodiment, the first fungal pesticide is the strain Metarhizium anisopliae F52 and the second fungal pesticide is a strain of Beauveria bassiana. In yet another embodiment, the first fungal pesticide is the strain Metarhizium anisopliae F52 and the second fungal pesticide is the strain Beauveria bassiana ATCC-74040. In still yet another embodiment, the first fungal pesticide is the strain Metarhizium anisopliae F52 and the second fungal pesticide is the strain Beauveria bassiana ATCC-74250.

In an embodiment, the first fungal pesticide controls bed bugs at the egg stage, the nymph stage, the instar stage, the adult stage, or combinations thereof. In another embodiment, the first fungal pesticide controls bed bugs at the egg stage, the nymph stage, the instar stage, the adult stage, or combinations thereof and is a strain of Metarhizium sp. In still another embodiment, the first fungal pesticide controls bed bugs at the egg stage, the nymph stage, the instar stage, the adult stage, or combinations thereof and is a strain of Metarhizium anisopliae. In yet another embodiment, the first fungal pesticide controls bed bugs at the egg stage, the nymph stage, the instar stage, the adult stage, or combinations thereof and is the strain Metarhizium anisopliae F52.

In a further embodiment, the second fungal pesticide controls bed bugs at the egg stage, the nymph stage, the instar stage, the adult stage, or combinations thereof. In another embodiment, the second fungal pesticide controls bed bugs at the egg stage, the nymph stage, the instar stage, the adult stage, or combinations thereof and is a strain of Beauveria sp. In still another embodiment, the second fungal pesticide controls bed bugs at the egg stage, the nymph stage, the instar stage, the adult stage, or combinations thereof and is a strain of Beauveria bassiana. In yet another embodiment, the second fungal pesticide controls bed bugs at the egg stage, the nymph stage, the instar stage, the adult stage, or combinations thereof and is the strain Beauveria bassiana ATCC-74040. In still yet another embodiment, the second fungal pesticide controls bed bugs at the egg stage, the nymph stage, the instar stage, the adult stage, or combinations thereof and is the strain Beauveria bassiana ATCC-74250.

In a further embodiment the first fungal pesticide controls bed bugs at the egg stage and the second fungal pesticide controls bed bugs at the adult stage. In another embodiment, the first fungal pesticide controls bed bugs at the egg stage and is a strain of Metarhizium sp. and the second fungal pesticide controls bed bugs at the adult stage and is a strain of Beauveria sp. In yet another embodiment, the first fungal pesticide controls bed bugs at the egg stage and is a strain of Metarhizium sp. and the second fungal pesticide controls bed bugs at the adult stage and is a strain of Beauveria bassiana. In still another embodiment, the first fungal pesticide controls bed bugs at the egg stage and is a strain of Metarhizium sp. and the second fungal pesticide controls bed bugs at the adult stage and is the strain Beauveria bassiana ATCC74040. In still yet another embodiment, the first fungal pesticide controls bed bugs at the egg stage and is a strain of Metarhizium sp. and the second fungal pesticide controls bed bugs at the adult stage and is the strain Beauveria bassiana ATCC74250.

In yet another embodiment, the first fungal pesticide controls bed bugs at the egg stage and is a strain of Metarhizium anisopliae and the second fungal pesticide controls bed bugs at the adult stage and is a strain of Beauveria sp. In yet another embodiment, the first fungal pesticide controls bed bugs at the egg stage and is a strain of Metarhizium anisopliae and the second fungal pesticide controls bed bugs at the adult stage and is a strain of Beauveria bassiana. In still another embodiment, the first fungal pesticide controls bed bugs at the egg stage and is a strain of Metarhizium anisopliae and the second fungal pesticide controls bed bugs at the adult stage and is the strain Beauveria bassiana ATCC74040. In still yet another embodiment, the first fungal pesticide controls bed bugs at the egg stage and is a strain of Metarhizium anisopliae and the second fungal pesticide controls bed bugs at the adult stage and is the strain Beauveria bassiana ATCC74250.

In still yet another embodiment, the first fungal pesticide controls bed bugs at the egg stage and is the strain Metarhizium anisopliae F52 and the second fungal pesticide controls bed bugs at the adult stage and is a strain of Beauveria sp. In yet another embodiment, the first fungal pesticide controls bed bugs at the egg stage and is the strain Metarhizium anisopliae F52 and the second fungal pesticide controls bed bugs at the adult stage and is a strain of Beauveria bassiana.

In a specific embodiment, the first fungal pesticide controls bed bugs at the egg stage and is the strain Metarhizium anisopliae F52 and the second fungal pesticide controls bed bugs at the adult stage and is the strain Beauveria bassiana ATCC74040. In another specific embodiment, the first fungal pesticide controls bed bugs at the egg stage and is the strain Metarhizium anisopliae F52 and the second fungal pesticide controls bed bugs at the adult stage and is the strain Beauveria bassiana ATCC74250.

Also described herein, are methods for treating and/or preventing bed bug infestations. The method comprises applying a first fungal pesticide and a second fungal pesticide, as described above, to a bed bug habitat. Non-limiting examples of bed bug habitats include furniture (e.g., beds generally, bed frames, bed head boards, bed foot boards, box springs generally, bed box springs, futon box springs, mattresses generally, bed mattresses, sofa mattresses, air mattresses, futon mattresses, chair mattresses, cushions generally, chair cushions, couch cushions, sofa cushions, chair cushions, chairs generally, couches generally, sofas generally, futons generally, bedding generally, dust ruffles, tables generally, coffee tables, dining tables, end tables, benches, clothing dressers generally, lighting fixtures generally, lamps, toy boxes generally, ottomans generally, foot rests generally, television stands generally, televisions generally, etc.), sleeping bags, moldings generally (e.g., crown molding, wainscoting, chair rail molding, trim molding, etc.), wall material (e.g., dry wall, plaster, sheet rock, brick, wood, etc.), drapery (e.g., curtains generally, blinds generally, valances, cornices, curtain rods, valance rods, curtain hardware, etc.) windows, temperature regulating devices (e.g., air-conditioning units, radiators, thermostats, heat pumps, heating units, etc.), toilets, sinks, tubs, shower rods, shower basins, and doors generally (e.g., bathroom doors, shower doors, closet doors, hallway doors, etc.); vehicles (e.g., airplanes generally, airplane seats, airplane storage areas, ships generally cruise ships, ship cabins, etc.) and any other surface where it would be advantageous to apply the compositions disclosed herein to control pests. In particular embodiments, bed bug habitats to be treated include areas where bed bugs are known to congregate (e.g., cracks and crevices in wall material, spaces between floor and wall adjacencies, etc.

The invention is further defined by the following numbered paragraphs:

1. A method for controlling pests comprising:
contacting one or more pests with (e.g., an effective amount of) a first fungal pesticide and a second fungal pesticide.

2. The method of paragraph 1, wherein the first fungal pesticide and the second fungal pesticide are different strains of the same species.

3. The method of paragraph 1, wherein the first fungal pesticide and the second fungal pesticide are strains of different species.

4. The method of paragraph 1, wherein the first fungal pesticide and the second fungal pesticide are applied sequentially or simultaneously.

5. The method of paragraph 1, wherein the first fungal pesticide is selected from the group consisting of Coelomycidium, Myiophagus, Coelemomyces, Lagenidium, Leptolegnia, Couchia, Sporodiniella, Conidiobolus, Entomophaga, Entomophthora, Erynia, Massospora, Meristacrum, Neozygites, Pandora, Zoophthora, Blastodendrion, Metschnikowia, Mycoderma, Ascophaera, Cordyceps, Torrubiella, Nectria, Hypocrella, Calonectria, Filariomyces, Hesperomyces, Trenomyces, Myriangium, Podonectria, Akanthomyces, Aschersonia, Aspergillus, Beauveria, Culicinomyces, Engyodontium, Fusarium, Gibellula, Hirsutella, Hymenostilbe, Isaria, Metarhizium, Nomuraea, Paecilomyces, Paraisaria, Pleurodesmospora, Polycephalomyces, Pseudogibellula, Sorosporella, Stillbella, Tetranacrium, Tilachlidium, Tolypocladium, Verticillium, Aegerita, Filobasidiella, Septobasidium, and Uredinella.

6. The method of paragraph 1, wherein the second fungal pesticide is selected from the group consisting of Coelomycidium, Myiophagus, Coelemomyces, Lagenidium, Leptolegnia, Couchia, Sporodiniella, Conidiobolus, Entomophaga, Entomophthora, Erynia, Massospora, Meristacrum, Neozygites, Pandora, Zoophthora, Blastodendrion, Metschnikowia, Mycoderma, Ascophaera, Cordyceps, Torrubiella, Nectria, Hypocrella, Calonectria, Filariomyces, Hesperomyces, Trenomyces, Myriangium, Podonectria, Akanthomyces, Aschersonia, Aspergillus, Beauveria, Culicinomyces, Engyodontium, Fusarium, Gibellula, Hirsutella, Hymenostilbe, Isaria, Metarhizium, Nomuraea, Paecilomyces, Paraisaria, Pleurodesmospora, Polycephalomyces, Pseudogibellula, Sorosporella, Stillbella, Tetranacrium, Tilachlidium, Tolypocladium, Verticillium, Aegerita, Filobasidiella, Septobasidium, and Uredinella.

7. The method of paragraph 1, wherein the first fungal pesticide and the second fungal pesticide are different strains of Metarhizium sp.

8. The method of paragraph 1, wherein the first fungal pesticide and the second fungal pesticide are different strains of Metarhizium anisopliae.

9. The method of paragraph 1, wherein one of the first fungal pesticide or the second fungal pesticide is the strain Metarhizium anisopliae F52.

10. The method of paragraph 1, wherein the first fungal pesticide and the second fungal pesticide are different strains of Beauveria sp.

11. The method of paragraph 1, wherein the first fungal pesticide and the second fungal pesticide are different strains of Beauveria bassiana.

12. The method of paragraph 1, wherein one of the first fungal pesticide or the second fungal pesticide is the strain Beauveria bassiana ATCC 74040.

13. The method of claim 1, wherein one of the first fungal pesticide or the second fungal pesticide is the strain Beauveria bassiana ATCC 74250.

14. The method of paragraph 1, wherein the first fungal pesticide is the strain Beauveria bassiana ATCC 74040 and the second fungal pesticide is the strain Beauveria bassiana ATCC 74250.

15. The method of paragraph 1, wherein the first fungal pesticide is a strain of Metarhizium sp. and the second fungal pesticide is a strain of Beauveria sp.

16. The method of paragraph 15, wherein the first fungal pesticide is a strain of Metarhizium sp. and the second fungal pesticide is a strain of Beauveria bassiana.

17. The method of paragraph 15, wherein the first fungal pesticide is a strain of Metarhizium sp. and the second fungal pesticide is the strain Beauveria bassiana ATCC 74040.

18. The method of paragraph 15, wherein the first fungal pesticide is a strain of Metarhizium sp. and the second fungal pesticide is the strain Beauveria bassiana ATCC 74250.

19. The method of paragraph 15, wherein the first fungal pesticide is a strain of Metarhizium anisopliae and the second fungal pesticide is a strain of Beauveria sp.

20. The method of paragraph 15, wherein the first fungal pesticide is a strain of Metarhizium anisopliae and the second fungal pesticide is a strain of Beauveria bassiana.

21. The method of paragraph 15, wherein the first fungal pesticide is a strain of Metarhizium anisopliae and the second fungal pesticide is the strain Beauveria bassiana ATCC 74040.

22. The method of paragraph 15, wherein the first fungal pesticide is a strain of Metarhizium anisopliae and the second fungal pesticide is the strain Beauveria bassiana ATCC 74250.

23. The method of paragraph 15, wherein the first fungal pesticide is the strain Metarhizium anisopliae F52 and the second fungal pesticide is a strain of Beauveria sp.

24. The method of paragraph 15, wherein the first fungal pesticide is the strain Metarhizium anisopliae F52 and the second fungal pesticide is a strain of Beauveria bassiana.

25. The method of paragraph 15, wherein the first fungal pesticide is the strain Metarhizium anisopliae F52 and the second fungal pesticide is the strain Beauveria bassiana ATCC 74040.

26. The method of paragraph 15, wherein the first fungal pesticide is the strain Metarhizium anisopliae F52 and the second fungal pesticide is the strain Beauveria bassiana ATCC 74250.

27. The method of paragraph 1, wherein the first fungal pesticide controls bed bugs at an egg stage, a nymph stage, an instar stage, an adult stage, or combinations thereof.

28. The method of paragraph 1, wherein the second fungal pesticide controls bed bugs at an egg stage, a nymph stage, an instar stage, an adult stage, or combinations thereof.

29. The method of paragraph 1, wherein the first fungal pesticide controls bed bugs at the egg stage and the second fungal pesticide controls bed bugs at the adult stage.

30. The method of paragraph 29, wherein the first fungal pesticide is a strain of Metarhizium sp. and the second fungal pesticide is a strain of Beauveria sp.

31. The method of paragraph 30, wherein the strain of Metarhizium sp. is Metarhizium anisopliae and the strain of Beauveria sp. is Beauveria bassiana.

32. The method of paragraph 31, wherein the strain of Metarhizium anisopliae is the strain Metarhizium anisopliae F52 and the strain of Beauveria bassiana ATCC 74040.

33. The method of paragraph 31, wherein the strain of Metarhizium anisopliae is the strain Metarhizium anisopliae F52 and the strain of Beauveria bassiana ATCC 74250.

34. The method of paragraph 1, wherein the first fungal pesticide, the second fungal pesticide, or both the first fungal pesticide and the second fungal pesticide are in a spore form.

35. The method of any of paragraphs 1-34, wherein the pest is a bed bug.

36. The method of any of paragraphs 1-34, wherein the pest is a plant pest.

37. A composition comprising a carrier, a first fungal pesticide, and a second fungal pesticide, wherein the first fungal pesticide is a strain of Metarhizium anisopliae and the second fungal pesticide is a strain of Beauveria bassiana.

38. The composition of paragraph 37, wherein the strain of Metarhizium anisopliae is the strain Metarhizium anisopliae F52 and the strain of Beauveria bassiana ATCC 74040.

39. The composition of paragraph 37, wherein the strain of Metarhizium anisopliae is the strain Metarhizium anisopliae F52 and the strain of Beauveria bassiana ATCC 74250.

40. The composition of paragraph 37, wherein the composition consist of additional ingredients selected from the group consisting of biologically active ingredients, chemical pesticides, biopesticides synergists, desiccants, insect growth regulators, attractants, surfactants, rheology modifying agents, preservatives, colorants, opacifiers, fragrances, fillers, pH adjusting agents, stabilizers, builders, buffers, antioxidants, oxygen scavenger, water absorbing agents, foams, humectants, wetting agents UV protectants, fillers, solvents, nutritive additives, electrostatic waxes, and combinations thereof.

41. The composition of paragraph 40, wherein the composition comprises a biologically active ingredient.

42. The composition of paragraph 41, wherein the biologically active ingredient is at least one enzyme, at least one additional microorganism, at least one metabolite, or a combination thereof.

43. The composition of paragraph 42, wherein the enzyme is a cuticle degrading enzyme.

44. The composition of paragraph 43, wherein the cuticle degrading enzyme is a protease, a peptidase, a chitinase, a chitosanase, a cutinase, or a lipase.

45. The composition of paragraph 42, wherein the at least one microorganism is at least one bacterium.

46. The composition of paragraph 45, wherein the at least one bacterium is of the genus Bacillus or Pseudomonas.

47. The composition of paragraph 40, wherein the composition comprises a pesticide.

48. The composition of paragraph 40, wherein the composition comprises an insect growth regulator.

49. The composition of paragraph 40, wherein the composition comprises an electrostatic carrier.

50. The composition of paragraph 49, wherein the electrostatic carrier is an electrostatic wax or powder.

51. The composition of paragraph 50, wherein the electrostatic wax or powder is a carnauba wax or powder.

### EXAMPLES

The following examples are provided for illustrative purposes and are not intended to limit the scope of the invention as claimed herein. Any variations in the exemplified examples which occur to the skilled artisan are intended to fall within the scope of the present invention.

### Example 1

### Mortality of Adult Bed Bugs when Exposed to Different Entomopathogens

An adult population of 50% males and 50% female were fed five days prior test. This insured that the insects were hydrated and that their nutritional needs were met.

The insects were exposed to the strain M. anisopliae strain F52 (F52) and two strains of Beauveria bassiana: B. bassiana ATCC 74040 (Bb40) and B. bassiana ATCC 74250 (Bb50). One (1) mL dilutions of each isolate were made in aqueous solution of 0.05% Tween 80 and confirmed by hemacytometer combined with germination counts to correspond to 1×10⁶, 1×10⁷, 1×10⁸, and 1×10⁹ viable spores/mL. The 1 mL dilutions were pipetted onto 6.0 cm by 1.5 cm Petri dish fitted with filter paper (Whitman No. 1, 5 cm diameter). Four (4) bed bugs (2 males and 2 females) were placed into each Petri dish and allowed to crawl in the dishes for 30 minutes (Plate 1). Controls (Chk) were the same as the treatments but without the fungus formulation (i.e., only 0.05% Tween 80 solution without fungus). Petri dishes were replicated 5 times for each treatment. After exposure, each insect was transferred individually into 2 ml holding vials with a breathing hole in the lid and kept in a desiccator over water at 92% relative humidity (RH) at 25° C.±1° C. for observation. Daily observations were made and recorded. Results are provided in Table 1.
Treatment #1—Untreated Check (Chk);
Treatment #2—F52 @ 1.0×10⁶ spores/mL;
Treatment #3—Bb50 @ 1.0×10⁶ spores/mL;
Treatment #4—Bb40 @ 1.0×10⁶ spores/mL;
Treatment #2—F52 @ 1.0×10⁷ spores/mL;
Treatment #3—Bb50 @ 1.0×10⁷ spores/mL;
Treatment #4—Bb40 @ 1.0×10⁷ spores/mL;
Treatment #2—F52 @ 1.0×10⁸ spores/mL;
Treatment #3—Bb50 @ 1.0×10⁸ spores/mL;
Treatment #4—Bb40 @ 1.0×10⁸ spores/mL;
Treatment #2—F52 @ 1.0×10⁹ spores/mL;
Treatment #3—Bb50 @ 1.0×10⁹ spores/mL; and
Treatment #4—Bb40 @ 1.0×10⁹ spores/mL.

TABLE 1
Percent survival of adult bed bugs over time following exposure to each
isolate at each concentration over time.

| | | F52 | Bb50 | Bb40 | F52 | Bb50 | Bb40 | F52 | Bb50 | Bb40 | F52 | Bb50 | Bb40 |
|---|---|---|---|---|---|---|---|---|---|---|---|---|---|
| Day | Chk | 1E6 | 1E6 | 1E6 | 1E7 | 1E7 | 1E7 | 1E8 | 1E8 | 1E8 | 1E9 | 1E9 | 1E9 |
| 0 | 100 | 100 | 100 | 100 | 100 | 100 | 100 | 100 | 100 | 100 | 100 | 100 | 100 |
| 1 | 100 | 100 | 100 | 100 | 100 | 100 | 100 | 100 | 100 | 100 | 100 | 100 | 100 |
| 2 | 100 | 100 | 100 | 100 | 100 | 100 | 80 | 100 | 100 | 100 | 100 | 135 | 90 |
| 3 | 100 | 100 | 90 | 90 | 145 | 100 | 80 | 95 | 95 | 100 | 100 | 70 | 85 |
| 4 | 100 | 90 | 55 | 70 | 100 | 100 | 80 | 70 | 55 | 90 | 70 | 45 | 5 |
| 5 | 100 | 85 | 55 | 40 | 95 | 70 | 50 | 35 | 0 | 55 | 15 | 5 | 5 |
| 6 | 100 | 85 | 50 | 35 | 85 | 70 | 40 | 30 | 0 | 50 | 15 | 5 | 0 |
| 7 | 95 | 80 | 40 | 20 | 50 | 70 | 5 | 10 | 0 | 0 | 0 | 0 | 0 |
| 8 | 95 | 80 | 40 | 20 | 50 | 70 | 0 | 10 | 0 | 0 | 0 | 0 | 0 |
| 9 | 95 | 80 | 40 | 20 | 40 | 65 | 0 | 10 | 0 | 0 | 0 | 0 | 0 |
| 10 | 95 | 80 | 40 | 20 | 40 | 65 | 0 | 10 | 0 | 0 | 0 | 0 | 0 |
| 11 | 95 | 75 | 35 | 20 | 40 | 60 | 0 | 5 | 0 | 0 | 0 | 0 | 0 |
| 12 | 95 | 75 | 30 | 20 | 35 | 50 | 0 | 5 | 0 | 0 | 0 | 0 | 0 |
| 13 | 95 | 75 | 25 | 20 | 35 | 50 | 0 | 5 | 0 | 0 | 0 | 0 | 0 |
| 14 | 80 | 75 | 25 | 20 | 35 | 50 | 0 | 0 | 0 | 0 | 0 | 0 | 0 |
| 15 | 80 | 70 | 20 | 20 | 30 | 50 | 0 | 0 | 0 | 0 | 0 | 0 | 0 |
| 16 | 80 | 70 | 20 | 20 | 30 | 50 | 0 | 0 | 0 | 0 | 0 | 0 | 0 |
| 17 | 80 | 65 | 20 | 20 | 30 | 50 | 0 | 0 | 0 | 0 | 0 | 0 | 0 |
| 18 | 65 | 65 | 20 | 15 | 30 | 50 | 0 | 0 | 0 | 0 | 0 | 0 | 0 |
| 19 | 60 | 65 | 20 | 15 | 30 | 50 | 0 | 0 | 0 | 0 | 0 | 0 | 0 |
| 20 | 60 | 65 | 20 | 15 | 30 | 50 | 0 | 0 | 0 | 0 | 0 | 0 | 0 |
| 21 | 60 | 65 | 20 | 15 | 30 | 50 | 0 | 0 | 0 | 0 | 0 | 0 | 0 |
| 22 | 55 | 65 | 20 | 10 | 30 | 50 | 0 | 0 | 0 | 0 | 0 | 0 | 0 |
| 23 | 55 | 65 | 20 | 10 | 30 | 50 | 0 | 0 | 0 | 0 | 0 | 0 | 0 |
| 24 | 50 | 65 | 20 | 10 | 30 | 50 | 0 | 0 | 0 | 0 | 0 | 0 | 0 |
| 25 | 50 | 65 | 20 | 10 | 30 | 50 | 0 | 0 | 0 | 0 | 0 | 0 | 0 |
| 26 | 50 | 65 | 20 | 10 | 30 | 50 | 0 | 0 | 0 | 0 | 0 | 0 | 0 |
| 27 | 50 | 65 | 20 | 10 | 30 | 50 | 0 | 0 | 0 | 0 | 0 | 0 | 0 |
| 28 | 50 | 60 | 20 | 10 | 30 | 50 | 0 | 0 | 0 | 0 | 0 | 0 | 0 |
| 29 | 50 | 60 | 15 | 10 | 25 | 30 | 0 | 0 | 0 | 0 | 0 | 0 | 0 |
| 30 | 50 | 60 | 15 | 10 | 25 | 15 | 0 | 0 | 0 | 0 | 0 | 0 | 0 |

The results demonstrate that the exposure of bed bug adults to the two Beauveria bassiana isolates (Bb40 and Bb50) result in higher mortality rates than exposure to the strain Metarhizium anisopliae F52.

### Example 2

### Effect of Different Entomopathogens on Bed Bug Eggs and Nymphs

Bed bug eggs were exposed to the strain M. anisopliae strain F52 (F52) and two strains of Beauveria bassiana: B. bassiana ATCC 74040 (Bb40) and B. bassiana ATCC 74250 (Bb50). Dilutions of each isolate were made in aqueous solution of 0.05% Tween 80 and confirmed by hemacytometer combined with germination counts to correspond to 1×10⁷ and 1×10⁸ viable spores/mL in 0.05% Tween 80. A solution of 0.05% Tween 80 was used as a control.

Four (4) bed bug eggs were placed in each 6.0 cm by 1.5 cm Petri dish fitted with a 1.5 cm diameter filter paper. Petri dishes were replicated 5 times for each treatment. Dilutions were shook well to suspend particulates in test solution. A 0.25 ml sample of each concentration was pipetted into 6.0 cm×1.5 cm Petri dish containing the eggs. Dishes were vented for 4-hours to allow for evaporation of excess moisture. Eggs were kept in the dishes for the remainder of the study. Dishes were kept at 25° C. with ambient relative humidity.

Treatments were as follows:
Treatment #1—Untreated Check (Chk);
Treatment #2—F52 @ 1.0×10⁷ spores/mL;
Treatment #3—F52 @ 1.0×10⁸ spores/mL;
Treatment #4—Bb50 @ 1.0×10⁷ spores/mL;
Treatment #5—Bb50 @ 1.0×10⁸ spores/mL;
Treatment #6—Bb40 @ 1.0×10⁷ spores/mL; and
Treatment #7—Bb40 @ 1.0×10⁸ spores/mL.

Evaluations were recorded on hatched/unhatched eggs and live/dead nymphs. Results are provided in Table 2.

TABLE 2
Percentage of total insects at each lifestage (unhatched, hatched, live nymph,
or dead nymph) following exposure of eggs to each isolate at each concentration over
time.

| Days After | | | | F52 | | F52 | | Bb50 | | Bb50 | | Bb40 | | Bb40 | |
|---|---|---|---|---|---|---|---|---|---|---|---|---|---|---|---|
| Application | Measure | Chk | | 1E7 | | 1E8 | | 1E7 | | 1E8 | | 1E7 | | 1E8 | |
| 2 | % | 0 | a | 0 | a | 5 | a | 15 | a | 5 | a | 0 | a | 0 | a |
| | Hatched | | | | | | | | | | | | | | |
| 2 | % | 100 | a | 100 | a | 95 | a | 85 | a | 95 | a | 100 | a | 100 | a |
| | Unhatched | | | | | | | | | | | | | | |
| 2 | % Live | 0 | a | 0 | a | 5 | a | 15 | a | 5 | a | 0 | a | 0 | a |
| | Nymphs | | | | | | | | | | | | | | |
| 2 | % Dead | 0 | a | 0 | a | 0 | a | 0 | a | 0 | a | 0 | a | 0 | a |
| | Nymphs | | | | | | | | | | | | | | |
| 4 | % | 50 | a | 10 | a | 15 | a | 55 | a | 25 | a | 45 | a | 20 | a |
| | Hatched | | | | | | | | | | | | | | |
| 4 | % | 50 | a | 90 | a | 85 | a | 45 | a | 75 | a | 55 | a | 80 | a |
| | Unhatched | | | | | | | | | | | | | | |
| 4 | % Live | 50 | a | 10 | a | 15 | a | 50 | a | 25 | a | 45 | a | 20 | a |
| | Nymphs | | | | | | | | | | | | | | |
| 4 | % Dead | 0 | a | 0 | a | 0 | a | 5 | a | 0 | a | 0 | a | 0 | a |
| | Nymphs | | | | | | | | | | | | | | |
| 6 | % | 95 | a | 10 | c | 15 | c | 65 | ab | 75 | ab | 85 | ab | 35 | bc |
| | Hatched | | | | | | | | | | | | | | |
| 6 | % | 5 | c | 90 | a | 85 | a | 35 | bc | 25 | bc | 15 | bc | 65 | ab |
| | Unhatched | | | | | | | | | | | | | | |
| 6 | % Live | 95 | a | 5 | d | 10 | d | 40 | bcd | 70 | abc | 85 | ab | 30 | cd |
| | Nymphs | | | | | | | | | | | | | | |
| 6 | % Dead | 0 | a | 5 | a | 5 | a | 25 | a | 5 | a | 0 | a | 5 | a |
| | Nymphs | | | | | | | | | | | | | | |
| 8 | % | 95 | a | 10 | c | 15 | c | 65 | ab | 75 | ab | 85 | ab | 35 | bc |
| | Hatched | | | | | | | | | | | | | | |
| 8 | % | 5 | c | 90 | a | 85 | a | 35 | bc | 25 | bc | 15 | bc | 65 | ab |
| | Unhatched | | | | | | | | | | | | | | |
| 8 | % Live | 95 | a | 5 | b | 10 | b | 35 | b | 30 | b | 30 | b | 10 | b |
| | Nymphs | | | | | | | | | | | | | | |
| 8 | % Dead | 0 | a | 5 | a | 5 | a | 30 | a | 45 | a | 55 | a | 25 | a |
| | Nymphs | | | | | | | | | | | | | | |
| 10 | % | 95 | a | 10 | c | 15 | c | 65 | ab | 75 | ab | 85 | ab | 35 | bc |
| | Hatched | | | | | | | | | | | | | | |
| 10 | % | 5 | c | 90 | a | 85 | a | 35 | bc | 25 | bc | 15 | bc | 65 | ab |
| | Unhatched | | | | | | | | | | | | | | |
| 10 | % Live | 95 | a | 0 | b | 10 | b | 15 | b | 25 | b | 30 | b | 10 | b |
| | Nymphs | | | | | | | | | | | | | | |
| 10 | % Dead | 0 | a | 10 | a | 5 | a | 50 | a | 50 | a | 55 | a | 25 | a |
| | Nymphs | | | | | | | | | | | | | | |
| 14 | % | 95 | a | 10 | c | 15 | c | 65 | ab | 75 | ab | 85 | ab | 35 | bc |
| | Hatched | | | | | | | | | | | | | | |
| 14 | % | 5 | c | 90 | a | 85 | a | 35 | bc | 25 | bc | 15 | bc | 65 | ab |
| | Unhatched | | | | | | | | | | | | | | |
| 14 | % Live | 95 | a | 0 | b | 5 | b | 15 | b | 25 | b | 30 | b | 10 | b |
| | Nymphs | | | | | | | | | | | | | | |
| 14 | % Dead | 0 | a | 10 | a | 10 | a | 50 | a | 50 | a | 55 | a | 25 | a |
| | Nymphs | | | | | | | | | | | | | | |
| 21 | % | 95 | c | 10 | a | 15 | a | 65 | bc | 75 | bc | 85 | bc | 35 | ab |
| | Hatched | | | | | | | | | | | | | | |
| 21 | % | 5 | c | 90 | a | 85 | a | 35 | bc | 25 | bc | 15 | bc | 65 | ab |
| | Unhatched | | | | | | | | | | | | | | |
| 21 | % Live | 95 | a | 0 | b | 5 | b | 15 | b | 20 | b | 30 | b | 10 | b |
| | Nymphs | | | | | | | | | | | | | | |
| 21 | % Dead | 0 | a | 10 | a | 10 | a | 50 | a | 55 | a | 55 | a | 25 | a |
| | Nymphs | | | | | | | | | | | | | | |

Means followed by same letter do not significantly differ (P = .05, Student-Newman-Keuls)

The results demonstrate that the exposure of bed bug eggs to the two Beauveria bassiana isolates (Bb40 and Bb50) result in higher egg hatch rates than exposure to the strain Metarhizium anisopliae F52.

It will be understood that the Specification and Examples are illustrative of the present embodiments and that other embodiments within the spirit and scope of the claimed embodiments will suggest themselves to those skilled in the art. Although this invention has been described in connection with specific forms and embodiments thereof, it would be appreciated that various modifications other than those discussed above may be resorted to without departing from the spirit or scope of the invention as defined in the appended claims. For example, equivalents may be substituted for those specifically described, and in certain cases, particular applications of steps may be reversed or interposed all without departing from the spirit or scope for the invention as described in the appended claims.

1. A method for controlling pests comprising:
contacting one or more bed bugs with a first fungal pesticide and a second fungal pesticide;
the first fungal pesticide including a strain of Metarhizium anisopliae or Beauveria bassiana; and
the second fungal pesticide including a strain of Metarhizium anisopliae or at least one strain of Beauveria bassiana.

2. (canceled)

3. (canceled)

4. The method of claim 1, wherein the first fungal pesticide and the second fungal pesticide are different strains of Metarhizium anisopliae.

5. The method of claim 1, wherein one of the first fungal pesticide or the second fungal pesticide is the strain Metarhizium anisopliae F52.

6. The method of claim 1, wherein the first fungal pesticide and the second fungal pesticide are different strains of Beauveria bassiana.

7. The method of claim 1, wherein one of the first fungal pesticide or the second fungal pesticide is the strain Beauveria bassiana ATCC 74040.

8. The method of claim 1, wherein one of the first fungal pesticide or the second fungal pesticide is the strain Beauveria bassiana ATCC 74250.

9. The method of claim 1, wherein the first fungal pesticide, the second fungal pesticide, or the first and second fungal pesticide, controls bed bugs at an egg stage, a nymph stage, an instar stage, an adult stage, or combinations thereof.

10. (canceled)

11. The method of claim 1, wherein the first fungal pesticide controls bed bugs at the egg stage and the second fungal pesticide controls bed bugs at the adult stage.

12. The method of claim 1, wherein the first fungal pesticide, the second fungal pesticide, or both the first fungal pesticide and the second fungal pesticide are in a spore form.

13. A composition comprising a carrier, a first fungal pesticide, and a second fungal pesticide, wherein the first fungal pesticide is a strain of Metarhizium anisopliae and the second fungal pesticide is a strain of Beauveria bassiana.

14. The composition of claim 13, wherein the strain of Metarhizium anisopliae is the strain Metarhizium anisopliae F52 and the strain of Beauveria bassiana is the strain Beauveria bassiana ATCC 74040 or Beauveria bassiana ATCC 74250.

15. (canceled)

16. The composition of claim 13, wherein the composition comprises one or more additional ingredients selected from the group consisting of biologically active ingredients, chemical pesticides, biopesticides synergists, desiccants, insect growth regulators, attractants, surfactants, rheology modifying agents, preservatives, colorants, opacifiers, fragrances, fillers, pH adjusting agents, stabilizers, builders, buffers, antioxidants, oxygen scavenger, water absorbing agents, foams, humectants, wetting agents UV protectants, fillers, solvents, nutritive additives, electrostatic waxes.

17. (canceled)

18. The composition of claim 16, wherein the biologically active ingredient is at least one enzyme, at least one additional microorganism, at least one metabolite, or a combination thereof.

19. The composition of claim 18, wherein the enzyme is a cuticle degrading enzyme.

20. The composition of claim 19, wherein the cuticle degrading enzyme is a protease, a peptidase, a chitinase, a chitosanase, a cutinase, or a lipase.

21. The method of claim 1, wherein the first fungal pesticide includes Metarhizium anisopliae F52 spores and the second fungal pesticide includes Beauveria bassiana ATCC 74040 spores or Beauveria bassiana ATCC 74250 spores.

22. The method of claim 1, wherein the first fungal pesticide includes Metarhizium anisopliae F52 spores and the second fungal pesticide includes Beauveria bassiana ATCC 74040 spores and Beauveria bassiana ATCC 74250 spores.

23. The method of claim 1, wherein the first fungal pesticide includes Beauveria bassiana ATCC 74040 spores and the second fungal pesticide includes Beauveria bassiana ATCC 74250 spores.

24. The composition of claim 13, wherein the strain of Metarhizium anisopliae is the strain Metarhizium anisopliae F52 and the strain of Beauveria bassiana is a combination of the strains Beauveria bassiana ATCC 74040 and Beauveria bassiana ATCC 74250.

25. A composition comprising a carrier, a first fungal pesticide and a second fungal pesticide, wherein the first fungal pesticide includes Beauveria bassiana ATCC 74040 and the second fungal pesticide includes Beauveria bassiana ATCC 74250.
